(19) United States
(12) Patent Application Publication
(10) Pub. No.: US 2017/0371306 A1
(43) Pub. Date: Dec. 28, 2017

(54) System and Method for Dispatching an Operation of a Distribution Feeder with Heterogeneous Prosumers

(71) Applicant: ECOLE POLYTECHNIQUE FEDERALE DE LAUSANNE (EPFL), Lausanne (CH)

(72) Inventors: Fabrizio Sossan, Preverenges (CH); Emil Namor, Chavannes (CH); Mario Paolone, La Conversion (CH)

(21) Appl. No.: 15/633,788

(22) Filed: Jun. 27, 2017

Related U.S. Application Data
(60) Provisional application No. 62/354,828, filed on Jun. 27, 2016.

(51) Int. Cl. G05B 13/04; H02J 3/06; H02J 5/00; H02J 3/00

(52) U.S. Cl. CPC G05B 13/048; H02J 5/00; H02J 3/06; H02J 2003/003

(57) ABSTRACT

A method for dispatching an operation of a distribution feeder of electrical power into a grid with heterogeneous prosumers, the method comprising the steps of establishing a dispatch plan on a computer by using forecast data of an aggregated consumption and local distributed generation at the grid for a predetermined period, and operating the distribution feeder according to the established dispatch plan during the predetermined period.

### CROSS-REFERENCE TO RELATED APPLICATIONS

The present invention claims priority to the U.S. provisional patent application with the Ser. No. 62/354,828 that was filed on Jun. 27, 2016, the entire contents thereof being herewith incorporated by reference.

### FIELD OF THE INVENTION

The present invention relates to the field of intelligent management of power distribution grids, networks, and distributed electrical systems, as well as the management of medium voltage distribution feeders for a power distribution network.

### BACKGROUND

In the field of smart grid management, the progressive displacement of conventional generation in favor of renewables requires to restore an adequate capacity of regulating power to assure reliable operation of interconnected power systems. An emerging concept to tackle this challenge is achieving the controllability of portions of distribution networks by exploiting controllable distributed generation (DG), flexible demand and storage. This paradigm can be traced in a number of frameworks, such as virtual power plants (VPPs) and grid-tied microgrids, which, in broad terms, consist in operating aggregates of heterogeneous resources to provide ancillary services to the upper grid layer, see for example references [1-3]. In general, solutions based on aggregating the capability of Distributed Energy Resources (DERs) require extended Information Communication Technology (ICT) infrastructures and efficient control policies to harvest flexibility until the LV distribution level, see for example references [4-6].

An essential aspect to enable the transition towards a smarter grid is the availability of plug-and-play solutions, namely technologies that can provide grid ancillary services in the current operational and regulatory framework with a reduced set of technical requirements and minimal levels of complexity. An example of research efforts in this direction is given by the proposition of directly coupling storage with stochastic renewable DG to achieve dispatchable operation, as shown for example references [7-9]. However, despite all the advancements in the art of smart grid management, additional and more effective solutions are desired. Specifically, among other problems, the background solutions are of difficult integration in the existing grid at the current stage because: (i) they might not offer the same reliability level as conventional generation, (ii) they require a radical change of the operational practices, and (iii) their technical requirements are not met or expensive to implement. Therefore, strongly improved smart grid management methods and systems are desired.

### SUMMARY

According to one aspect of the present invention, a method for dispatching an operation of a distribution feeder of electrical power into a grid with heterogeneous prosumers is provided. Preferably, the method includes the steps of establishing a dispatch plan on a computer by using forecast data of an aggregated consumption and local distributed generation at the grid for a predetermined period; and operating the distribution feeder according to the established dispatch plan during the predetermined period.

According to another aspect of the present invention, a smart power system is provided, the system including a grid connect point to connect to a power grid, a plurality of prosumers, a distribution feeder, a battery energy storage device, and a computer controller. Preferably, the computer controller is configured to establish a dispatch plan by the computer controller by using forecast data of an aggregated consumption and local distributed generation at the power grid for a predetermined period, and configured to operate the distribution feeder according to the established dispatch plan during the predetermined period.

According to still another aspect of the present invention, a non-transitory computer readable medium is provided, the computer readable medium having computer instructions recorded thereon, the computer instructions configured to perform a method for dispatching an operation of a distribution feeder for electrical power into a grid when performed on a computer. Preferably, the method includes the steps of establishing a dispatch plan on a computer by using forecast data of an aggregated consumption and local distributed generation at the grid for a predetermined period; and operating the distribution feeder according to the established dispatch plan during the predetermined period.

According to some aspects of the present invention, it is possible to achieve dispatchability of one or more distribution feeders through prosumers data driven forecasting and model predictive control of an electrical energy storage, for example electrochemical storage.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS AND TABLES

The accompanying drawings, which are incorporated herein and constitute part of this specification, illustrate the presently preferred embodiments of the invention, and together with the general description given above and the detailed description given below, serve to explain features of the invention.

FIG. 1 schematically shows an experimental system used to validate the dispatchable feeder concept: a medium-voltage (MV) distribution feeder with a number of buildings of the EPFL campus equipped with roof-top photovoltaic (PV) installations, and a battery energy storage systems (BESS), or another type of electrical energy storage device or system, for example a type of electrochemical storage. The control framework relies on a minimally invasive monitoring infrastructure: it requires the knowledge of the aggregated power flow at the GCP and the BESS injection;

FIG. 2 schematically shows the dispatchable feeder operation: the day before operation, the dispatchable feeder operator determines the dispatch plan for the next day. This might be submitted to the load balance responsible and used to enhance the scheduling of conventional generation, for example in the day-ahead market. During operation, the dispatchable feeder operator is committed to track the dispatch plan;

FIG. 3 shows a schematic representation of the first thirty-one (31) 10-second intervals of the day of operation. The situation sketches the situation at the beginning of the time interval 2;

FIG. 4 shows a schematic representation of an equivalent circuit model of the BESS. The quantities and are respectively the BESS terminal voltage and DC current, while υ_{C}_{₁}, υ_{C}_{₂}, υ_{C}_{₃} are the components of the state vector x;

FIG. 5 shows a graph that represents the autocorrelation function (ACF) of model residuals (full line) and white noise (horizontal lines) at 95% confidence level;

FIG. 6 shows a flow chart showing real-time operation during twenty-four (24) hours;

FIG. 7 shows graphs of experimental results during day scenario 0;

FIG. 8 shows graphs of experimental results during day scenario 1;

FIGS. 9A, 9B, and 9C show graphs showing load levelling experimental results, with an intra-day dispatch plan, day ahead problem, with FIG. 9A showing the forecasted consumption \hat{L} in a grey line and the dispatch plan \hat{P} as a solid black line, FIG. 9B showing the offset profile F, and FIG. 9C showing the forecasted BESS SOC behavior SÔE;

FIGS. 10A, 10B, and 10C show graphs representing load levelling experimental results, intra-day dispatch plan, with FIG. 10A showing the actual prosumption L in a grey line, and the sum of prosumption and BESS contribution P in a black line, and the levelled dispatch plan \hat{P} in a thick grey line, FIG. 10B showing the actual BESS power injections B along the day compared to the offset profile F, and FIG. 10C showing the evolution of the BESS SOC SOE as compared to the forecasted BESS SOC behavior SÔE;

FIG. 11 schematically shows a hardware computer system that can be used for performing the dispatch plan;

Table I shows estimated BESS voltage model parameters for different SOC ranges;

Table II shows performance metrics for two experimental day-scenarios (in Percentage); and

Table III shows performance metrics for the load-levelling experiment.

Herein, identical reference numerals are used, where possible, to designate identical elements that are common to the figures. Also, the images of the figures are simplified for illustration purposes and may not be depicted to scale.

### BRIEF DESCRIPTION OF THE SEVERAL EMBODIMENTS

According to one aspect of the present invention, two concepts are merged to achieve the dispatchability of distribution feeders with DG by controlling utility-scale battery energy storage systems (BESSs). Specifically, a method and system to dispatch the operation a group of a prosumers is presented, characterized by both conventional power demand and power generation, according to a scheduled prosumption trajectory at an exemplary five (5) minutes resolution, called dispatch plan, established the day before operation by implementing forecast of the local prosumption. In this variant, no intra-day redispatch is performed. During real-time operation, the mismatch between the dispatch plan and prosumption realization is corrected by adjusting the real power injections of the BESS converter with model predictive control (MPC). MPC is designed track the dispatch plan while obeying to BESS voltage, current and SOC constraints, which are modeled thanks to prediction models. Both battery and consumption forecasting models are data-driven, and can be identified from experimental measurements.

The method according to another aspect of the present invention is experimentally validated by dispatching the operation of a 20 kV medium voltage distribution system of the campus of the Ecole Polytechnique Fédérale de Lausanne (EPFL) in Switzerland, called dispatchable feeder, by using a grid-connected 720 kVA/500 kWh BESS placed at the root of the feeder. The dispatchable feeder includes a number of office buildings with conventional demand and 95 kWp rooftop PV DG. It relies on a minimally invasive monitoring infrastructure, and requires only the power flow at the grid connection point (GCP) and the information from the battery management system (BMS).

The benefits and advantages of the proposed method for achieving dispatched operation by design of distribution systems are two-fold. At system level, it allows to reduce the uncertainty associated to prosumption operation, which is known to increase balancing power requirements and system costs. See for example references [10, 11]. At local level, the dispatch plan is generated to meet the requirements of local distribution systems operation, for example to perform consumption peak shaving. In comparison with methodologies that have been proposed in the literature to achieve the controllability of heterogeneous clusters of prosumers, the suggested method is characterized by a low complexity in terms of metering, computation and communication requirements. Indeed, the principal coordination mechanism is given by the commitment of the operator to track the dispatch plan, without involving complex iterations or real-time communication.

Moreover, the two-stage formulation similar to the conventional way of operating the power system (day-ahead planning and intra-day operation) could facilitate the integration in the current grid operational paradigm. The following features and improvements as compared to the background art can be observed. (1) The formulation of a BESS-based control strategy to dispatch the operation of a group of heterogeneous stochastic and uncontrollable prosumers according to a trajectory established the day before operation; (2) a short-term energy management MPC strategy for the BESS which implements predictive constraints on the BESS current, voltage and SOC while retaining a convex formulation of the underlying optimization problem; and (3) experimental validation of the proposed method on a real-scale and real-life grid.

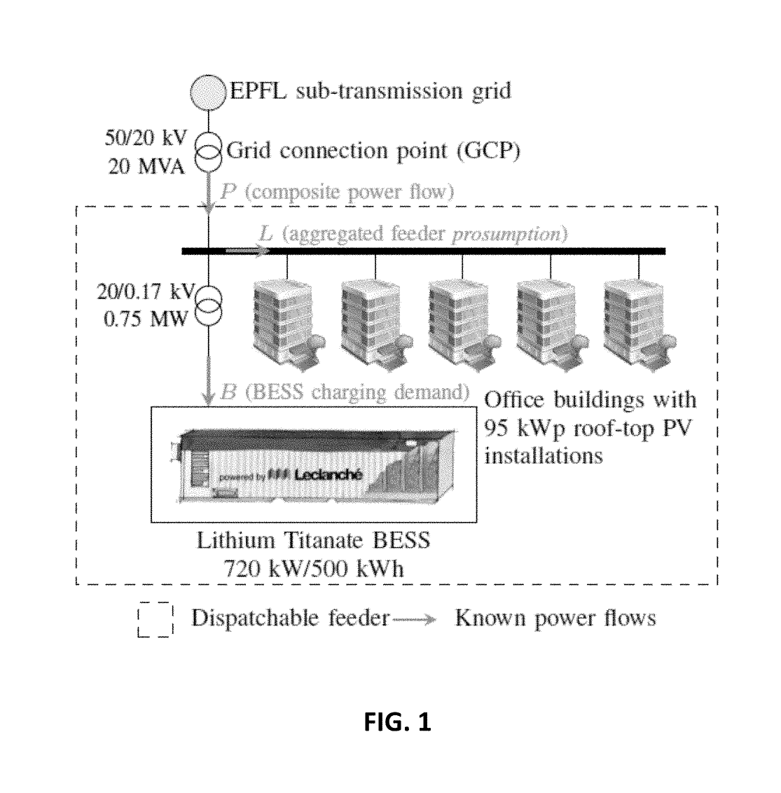

A distribution network populated by an unknown mix of electric loads is considered for the application of the method according to an aspect, possibly with distributed generation too, and equipped with a BESS. The considered scenario is well exemplified by the adopted experimental configuration, which is schematically depicted in FIG. 1 it includes a group of buildings of the EPFL campus with 350 kW of peak consumption and equipped with 95 kWp root-top PV installations and a grid connected 720 kVA/500 kWh Lithium Titanate BESS. The BESS bidirectional real power flow is denoted by B, while P is the composite power transit as seen at the GCP. The BESS is equipped with a four-quadrant converter. However, only the real power axis is considered. The former is the control variable, and its actual realization is available from measurements. The latter is known by information from a phasor measurement unit (PMU) placed at the root of the feeder [12]. The aggregated feeder demand is denoted by L, and, by neglecting grid losses, it is estimated as L=P−B. In general, L consists of both demand and generation and, in the following, it will be simply denoted as prosumption. For both buildings and BESS, the passive sign notation is used, namely positive values denote consumption, while negative denote injections towards the GCP. At the current stage, it is assumed that the local distribution feeder has ample capacity and characteristics to always operate within its voltage and lines ampacities technical constraints.

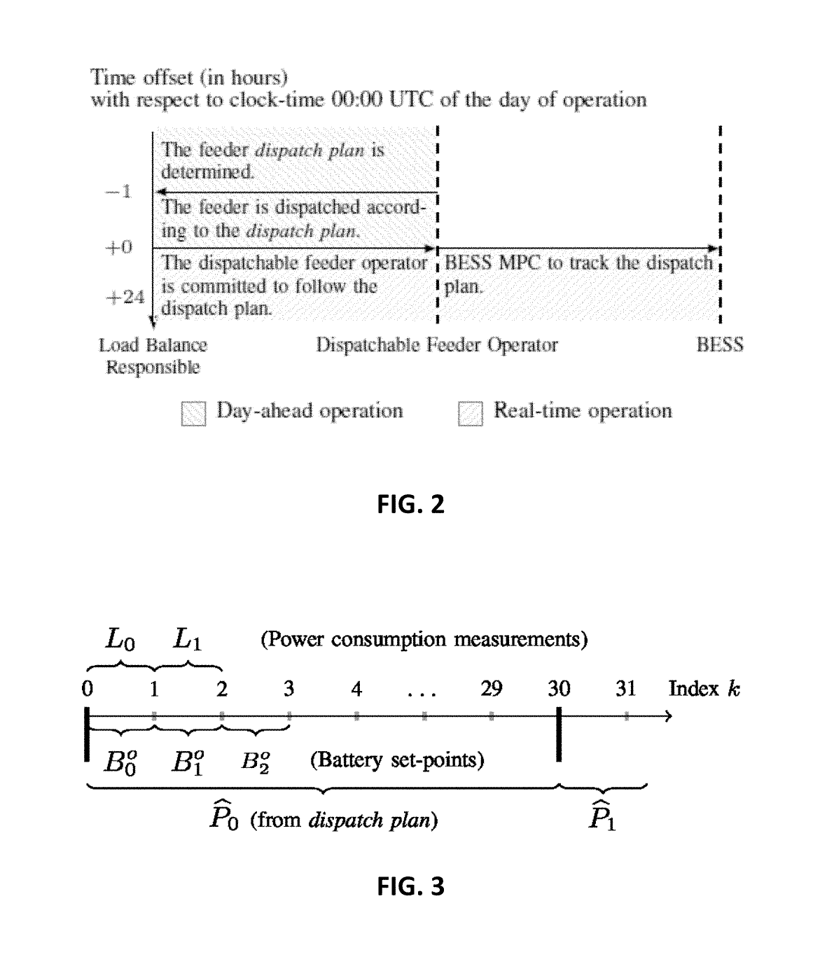

The problem consists in dispatching the feeder such that that the composite power transit at the GCP follows a power consumption sequence with five (5) minutes resolution, called dispatch plan, which is established the day before operation. Similarly to the conventional way of planning power system operation, the control strategies has a two-stage process, as schematically shown in FIG. 2.

Regarding stage one of the process, for the day-ahead operation, the dispatchable feeder operator determines the dispatch plan based on forecast on the prosumption and accounting also for the energy necessary to restore an adequate BESS state-of-charge (SOC) to establish a minimum level of up/down regulation capacity. The dispatch plan consists in a sequence of power consumption values with a small resolution, for example a five (5) minutes resolution, that the feeder should follow during the next day of operation. The resolution time period can also be chosen to be different than five minutes, for example, it is possible to choose the resolution time period in a range between ten (10) seconds to one hour, and can be chosen depending on electricity market regulations. Generally, with longer resolution times, the control performances decreases, so it is preferable to work with the shortest possible resolution time periods permitted by regulations of the electricity market. The day-ahead procedure is repeated every day. However, it is also possible to determine the dispatch plan more than one day ahead, for example a two, three or more days ahead. At the current stage, the dispatch plan is arbitrarily chosen to perform one hour before the beginning of real-time operation. At clock-time 00:00 UTC of the next day, the dispatch plan comes into effect and real-time operation begins. This phase is detailed in more detail below under the day-ahead problem.

Regarding stage two of the process, the real-time operation, this stage starts at clock-time 00:00 UTC of the day of operation, and lasts for the next 24 hour period. The dispatchable feeder operator adjusts the BESS power injection B to compensate for the mismatch between the dispatch plan and the power prosumption realization, which are likely to occur due to forecasting errors. This is accomplished by applying model predictive control (MPC), accounting for the dynamic behavior of the BESS voltage and SOC thanks to dynamic grey-box models identified from BESS measurements, and including short-term forecast of the prosumption. This procedure is explained in detail below with respect to the real-time operation. The choice of the five (5) minute dispatch interval is according to the envisaged trend for real-time electricity markets, but a different interval can be chosen. Although not specifically discussed in this work, this formulation potentially allows for day-ahead scheduling considering also dynamic electricity prices, for example as used in the references [13-15].

In the day-ahead problem, an objective is to determine the dispatch plan, that is the power consumption profile with a small resolution, for example a five (5) minutes resolution that the feeder should follow during next day operation. This is denoted as the sequence \hat{P}ᵢ, i=0, 1, . . . , N−1 where the index i denotes the 5-minute interval of the day of operation and N=288 is the number of five minute intervals in 24 hours. It is defined as:

\hat{P}ᵢ=\hat{L}ᵢ+Fᵢ^{o}, i=0, . . . ,N−1, (1)

where \hat{L}₀, . . . , \hat{L}_{N-1} are prosumption point predictions, determined as further described below, and the sequence F₀^{o}, . . . , F_{N-1}^{o} is called offset profile, and the notation o stays for “optimal” and denotes the output of an optimization problem, as detailed further below. The latter accounts for the amount of energy necessary to restore an adequate BESS SOC such that enough energy is available in the BESS to compensate for the mismatch between the dispatch plan and the prosumption realization for the incoming day. Indeed, at the end of the day of operation, the BESS SOC might be close to the upper or lower bounds. The offset plan accounts for this and restores a suitable level of BESS flexibility. It is computed by applying a robust optimization problem as described below with respect to the determination of the offset profile. As also envisaged in reference [9], including the offset in the dispatch plan to plan the BESS SOC a is a key feature to enable aware continuous time operation, thus avoiding the need of assuming an initial BESS SOC or imposing a dedicated constraint for the final SOC at the end of the day of operation, see for example in references [16-18].

For the day-ahead prosumption forecasting, although being an established methodology for high levels of aggregation, consumption and generation forecasting at local level is a relatively unexplored topic. It recently come to prominence especially in connection to large scale deployment of distributed generation in distribution networks, micro-grids operation, flexible demand management and thanks to the progressive availability of metering infrastructure at the low-voltage level, for example see in references [19-22]. Local prosumption is characterized by high volatility due to the reduced spatial smoothing effect, in case for example of PV generation, and prominence of isolated stochastic events, such as induction motors inrushes due to the insertion of pumps or elevators. Because of these reasons, existing forecasting methodologies developed considering high levels of aggregation, for example see in reference [23], might fail in forecasting low populated aggregates of prosumers. For the proposed method, a fairly simple non-parametric forecasting strategy is applied that is able to capture the prosumption daily and seasonal components with a decent level of accuracy. As it will be detailed in the following, the method includes the steps of selecting and averaging a number of historical power consumption sequences that are relevant for the period to predict according to the value of certain prosumption data features. It is important to note, that the described dispatch process is independent of the selected forecasting method.

Regarding the training data set, a series of historical power prosumption measurements are considered, collected at the GCP at five (5) minutes resolution organized in daily sequences of length, the bold typeface denotes an array of real values obtained by stacking time varying quantities:

l_{y,d}=[l_{y,d,l},l_{y,d,2}, . . . ,l_{y,d,N-1}] (2)

where y and d respectively denotes the calendar year and calendar day-of-year of the observation. The observations at 5 minutes resolution are obtained by average downsampling the original historical time series, which was with 20 milliseconds resolution. Also, historical measurements of the daily global horizontal radiation (day□) are available and are denoted by R_{y,d}, each data point is obtained by integrating observations at ten (10) minutes resolution of the global horizontal irradiance (GHI) over a twenty-four (24) hours period, from the online weather data source MeteoSwiss, weather station “Lausanne freiland.” (0037) Regarding the forecast computation, assumed to be at a given day, the objective is to determine the prosumption forecast at five (5) minutes resolution for the time interval from hour 0 UTC (Coordinated Universal Time) to 24 UTC of the incoming day, called target day. The information associated to the target day are the calendar day-of-year d*, calendar year y*, and the forecasted global horizontal radiation R*. The last information is obtained by applying the model in [24] starting from forecast of the cloud coverage, for example the one obtained for Lausanne by using NorwayMet services. The cloud coverage to GHI conversion model requires the clear-sky radiation, which is computed for Lausanne by using the clear-sky model implementation available in the open source geographical information system GRASS as shown in references [25, 26], which allows to account for the topological shading induced by geographical features on the horizon. The first step to compute the prosumption forecast is to select from the historical data a number of sequences with similar features as those of the target day. This is done by applying the following heuristic:

First, a set Ω_{A} is composed by selecting among historical observations the couples (y, d) which refer to calendar non-working days, for example weekends and bank holidays, if (y*, d*) correspond to a non-working day, and vice-versa.

Second, a set SL is obtained by selecting the first ten (10) couples (y, d) in Ω_{A} chosen in increasing order of distance in time with respect to the target day. The distance in time is evaluated as |365·(y−y*)+(d−d*)|

Third, set Ω_{C} is obtained by selecting the first five (5) couples (y, d) in Ω_{B} chosen in increasing order of distance between the respective observed cumulated irradiance R_{y,d} and the target radiance R*, evaluated as |R*−R_{y,d}|.

Summarizing, the set Ω_{C} is composed of five (5) couples of indexes (y, d) which are (i) closest in time to the target-day, (ii) same kind as the target day, and (iii) closest in amount of radiation to the GHI forecast for the target-day.

Finally, the couples in Ω_{C} are used to select as many sequences of historical prosumption measurements, which are regarded to as potential realizations of the next day prosumption. In particular, the set with the estimates of the presumption realization is given as:

[symbol]

={l_{d,y,i}∀(d,y)εΩ_{C}}, (3)

for each time interval i=0, 1, 2, . . . , N−1. The presumption point predictions \hat{L}₀, . . . , \hat{L}_{N-1} are obtained by averaging the elements in the respective estimates sate:

$${\hat{L}}_{i} = {\sum }_{l ∈}^{B} l , i = 0 , 2 , … , N - 1. \qquad ( 4 )$$

The outdoor temperature is not included as an influential variable in the selection process of the historical profiles: this is because the considered group of buildings are not equipped with electric space heating. Moreover, the dependency between PV generation and temperature is neglected at this stage.

Regarding the determination of the offset profile, the BESS injection required during real-time operation to compensate the mismatch between the dispatch plan and the prosumption realization Lᵢ is given as:

Bᵢ=\hat{P}ᵢ−Lᵢ=\hat{L}ᵢ+Fᵢ^{o}−Lᵢ, i=0, . . . ,N−1 (5)

where (1) has been used in the last equality to render \hat{P}ᵢ. Because Lᵢ is unknown at the current time, it is modelled as a random realization lᵢ from the uncertainty set [symbol] . Therefore from Equation (5), an estimate \hat{B}ᵢ of the BESS compensation action at time interval i is:

\hat{B}ᵢ=Fᵢ^{o}+L̅ᵢ−lᵢ, lᵢε [symbol] . (6)

The evolution of the BESS state-of-charge (SOC) as a function of the charge (discharge) positive (negative) power flow \hat{B}ᵢ is modelled by:

SOCᵢ₊₁=SOCᵢ+β(\hat{B}ᵢ)·Bᵢ (7)

where β(\hat{B}ᵢ) is the charge/discharge efficiency

$$β ( {\hat{B}}_{i} ) = \{ \begin{matrix}{β}^{+} = {T}_{s} / 3600 \cdot η , & {\hat{B}}_{i} \geq 0 \\ {β}^{-} = {T}_{s} / 3600 \cdot 1 / η , & {\hat{B}}_{i} < 0\end{matrix} ,$$

Tₛ=300 is the length of the discretization step, and η=0.95 is the conversion efficiency assessed from experimental measurements. The lowest possible BESS SOC is given by propagating the dynamic Equation (7) from an initial state-of-charge SOC₁ accounting for the greatest lower bound of the BESS power:

SOCᵢ₊₁^{↓}=SOCᵢ^{↓}+β·inf{\hat{B}ᵢ}, (9)

Since the dispatch plan is computed one hour before the beginning of the day of operation, the initial BESS state-of-charge SOC₀ is unknown and should be therefore predicted. At the current stage, a persistent predictor is used, namely SOC₀=SOC_{-5×12}. The BESS power lower bound inf{\hat{B}ᵢ} can be expressed by using Equation (6) and considering the largest possible prosumption stochastic realization lᵢ^{↑}.

inf{\hat{B}ᵢ}=Fᵢ^{o}+\hat{L}ᵢ−lᵢ^{↑}, (10)

where

$${l}_{i}^{} = {sup}_{{l}_{i} ∈} \{ {l}_{i} \} . \qquad ( 11 )$$

Replacing Equation (10) into Equation (9) yields

SOCᵢ₊₁^{↓}=SOCᵢ^{↓}+β(·)·(Fᵢ^{o}+\hat{L}ᵢ−lᵢ^{↑}). (12)

Conversely, the lowest upper bound of the BESS power and highest possible BESS SOC are:

sup{\hat{β}ᵢ}=Fᵢ^{o}+\hat{L}ᵢ−lᵢ^{↓},

SOCᵢ₊₁^{↑}=SOCᵢ^{↑}+β(·)·(Fᵢ^{o}+\hat{L}ᵢ−lᵢ^{↓}). (12)

where

$${l}_{i}^{} = {inf}_{{l}_{i} ∈} \{ {l}_{i} \} . \qquad ( 14 )$$

Finally, the offset profile F^{o}=[F₀^{o}, . . . , F_{N-1}^{o}] is determined by a robust optimization problem such that the BESS compensation action respects the BESS operational constraints. Specifically, the lowest and highest SOC values of Equations (9) and Equation (13), BESS power flow must observe their respective allowed limits. The sequence is F^{o}, where F denotes a sequence of optimization variables corresponding to F^{o}, which instead denotes the output of the optimization problem:

$${argmin}_{{F ∈ {ℝ}^{N}}_{{s}^{} , {s}^{} , {b}^{} , {b}^{} ∈ {ℝ}_{+}^{N}}} \{ {\sum }_{i = 1}^{N} {F}_{i}^{2} + α {\sum }_{i = 1}^{N} ( {s}_{i}^{} + {s}_{i}^{} + {b}_{i}^{} + {b}_{i}^{} ) \} \qquad ( 15 )$$

subject to

SOCᵢ^{↓}+β(·)·(Fᵢ+\hat{L}ᵢ−lᵢ^{↑})≧SOCₘᵢₙ−sᵢ^{↓},

SOCᵢ^{↑}+β(·)·(Fᵢ+\hat{L}ᵢ−lᵢ^{↓})≦SOCₘᵢₙ+sᵢ^{↑},

Fᵢ+\hat{L}ᵢ−lᵢ^{↑}≧Bₘₐₓ−bᵢ^{↓}

Fᵢ+\hat{L}ᵢ−lᵢ^{↓}≦Bₘₐₓ−bᵢ^{↑}

\hat{P}ᵢ≦Pₘₐₓ (16)

for i=0, . . . , N−1, and where

s^{↑}=[s₁^{↑}, . . . ,s_{N}^{↑}], s^{↓}=[s₁^{↓}, . . . ,s_{N}^{↓}]

b^{↑}=[b₁^{↑}, . . . ,b_{N}^{↑}], b^{↓}=[b₁^{↓}, . . . ,b_{N}^{↓}],

are sequences of positive slack variables to relax the otherwise hard constraints in Equation (16). The slack variables are weighted in Equation (5) with a large positive coefficient α (e.g. 1e⁶) such to have a predominant magnitude in the cost function. Their presence allows the optimization problem to converge also when the corresponding hard constraints are not met, even if at a very large cost. Finally, the last inequality constraint in Equation (16) is to make sure that the dispatch plan is smaller than a tunable threshold, the value of which can be designed by the modeler to peak shave the real power transit at the GCP. The formulation in Equations (15)-(16) is nonconvex due to the relationship expressed in Equation (8). In the real implementation, an equivalent convex formulation is solved, which is shown in further below.

The equations provided above discuss the formulation and validation of the dispatch plan and of the associated control problem, but does not discuss the BESS sizing problem. Nevertheless, the two couples of slack variables (s^{↑},s^{↓}) and (b^{↑},b^{↓}) discussed above give already practical indications whether the BESS power and energy capacities are enough to compensate for the estimated presumption uncertainty.

Regarding the load levelling, an alternative formulation is proposed for performing the load levelling in comparison to the background art. Generally, the load levelling signifies that the power flow at the grid connection point needs to be kept as flat as possible, in other words, the goal is to smoothen the power flow to remove periods with large power flow values. On an aggregate side, this has the effect of reducing and avoiding the activation of generation units, thereby it is possible to reduce prices for electricity. The average daily prosumption is defined as:

$$\hat{L} = {\sum }_{i = 0}^{N - 1} {\hat{L}}_{i} . \qquad ( 17 )$$

The offset profile is now determined such that the dispatch plan is as smooth as possible. This is given by finding an offset profile to minimize the following cost expression:

$${argmin}_{{F ∈ {ℝ}^{N}}_{{s}^{↑} , {s}^{↓} , {b}^{↑} , {b}^{↓} ∈ {ℝ}_{+}^{N}}} \{ {\sum }_{i = 1}^{N} {( ( {\hat{L}}_{i} - \hat{L} ) - {F}_{i} )}^{2} ++ α {\sum }_{i = 1}^{N} ( {s}_{i}^{↑} + {s}_{i}^{↓} + {b}_{i}^{↑} + {b}_{i}^{↓} ) \} \qquad ( 18 )$$

The Equation (18) expressed above is subject to the same constraints that have been expressed in the Equation (16).

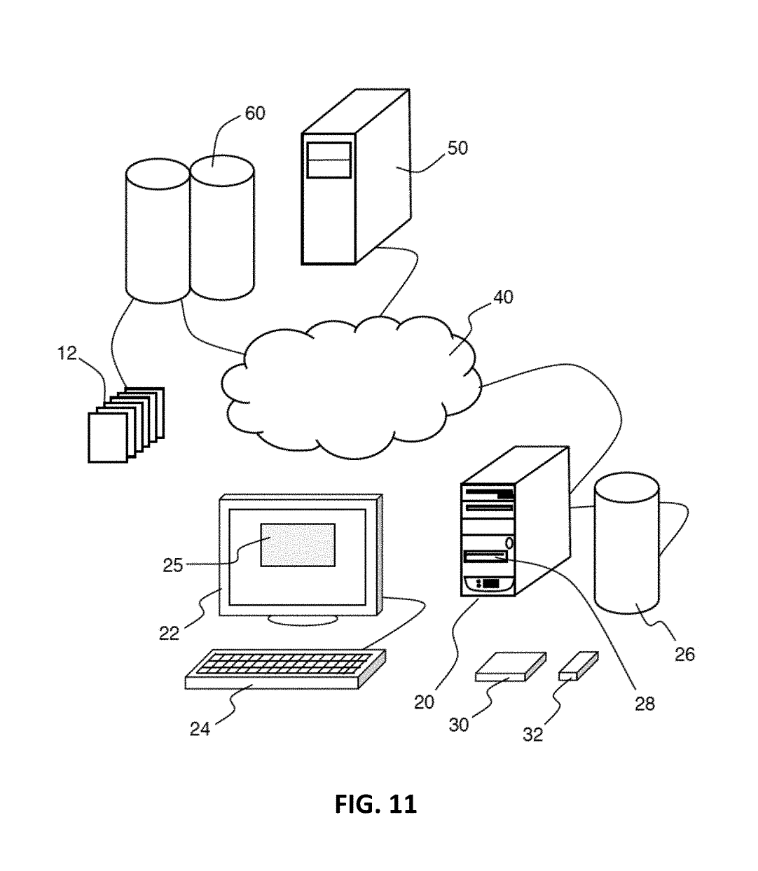

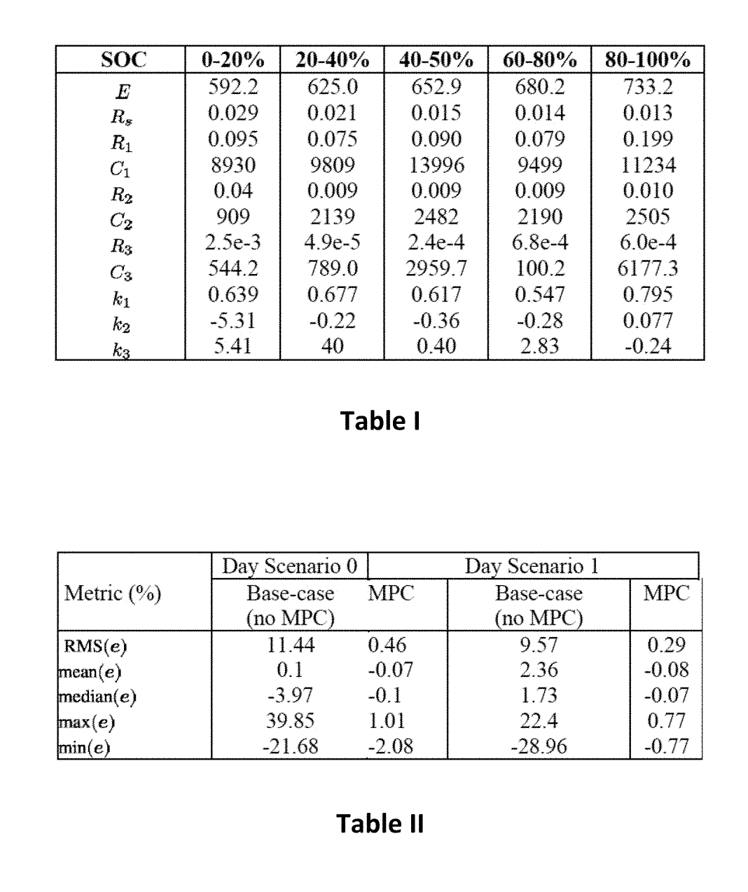

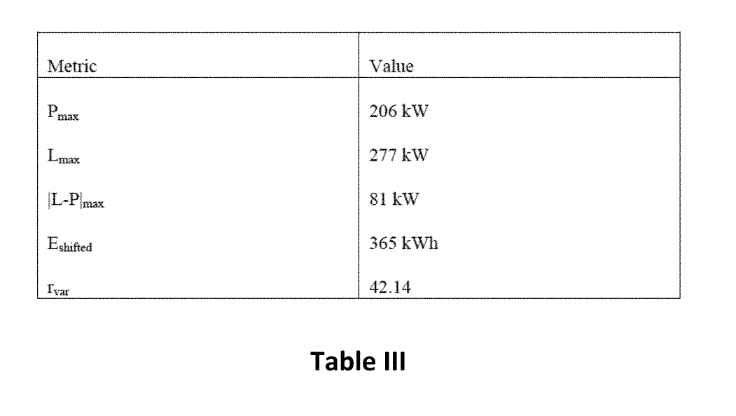

Regarding the implementation of the day-ahead strategy, to briefly summarize, the day-ahead strategy consists in first computing the forecast for the next day of operation \hat{L}₀, . . . , \hat{L}_{N-1}, as described previously. Therefore, the offset profile F₀^{o}, . . . , F_{N-1}^{o} is computed by solving the optimization problem expressed in Equations (15)-(16), finally allowing the computation of the dispatch plan \hat{P}₀, . . . , \hat{P}_{N-1} with Equation (1). The day-ahead strategy is implemented as a Matlab™ script and it is scheduled for operation every day at hour 23 UTC. The implementation of the forecast computation and the establishment of the dispatch plan can be done as shown below with respect to the hardware implementation in real-time operation, and as shown in FIG. 11. For example, the processing device 20 can be a computer controller equipped with an Intel i5 personal computer (PC) operating a Debian™ operating system (OS).

Regarding the real-time operation to operate the dispatch plan, the objective of real-time operation is to adjust the BESS real power injection in order that the average prosumption value in the current 5-minute interval matches the respective set-point from the dispatch plan. The control objective has been formalized supra regarding the day-ahead prosumption forecasting, Equations (2)-(4). Beforehand, the following notation is introduced:

(a) The control strategy is actuated with a sample time of 10 s; the period has been chosen in order to capture early time battery dynamics and assure good control performance.

(b) The index k=0, 1, 2, . . . , K−1 denotes the rolling 10 seconds time interval of the current day of operation, where K=8640 is the number of 10 seconds period in 24 hours;

(c) At the beginning of each interval k, the real power flow at the GCP, the BESS flow, and the real power of the prosumption realization for the previous interval k−1 become known due to measurements. They are respectively denoted by Pₖ₋₁, Bₖ₋₁ and Lₖ₋₁. It is noted that, although the BESS power flow is the chosen control variable, its actual realization might differ due to imprecise actuations of the converter and BESS transformer losses.

(d) The value of the prosumption set-point to match, denoted by Pₖ*, is retrieved from the dispatch plan \hat{P}₀, \hat{P}₁, . . . , \hat{P}_{N-1} as:

$${P}_{k}^{*} = {\hat{P}}_{⌊ \frac{k}{30} ⌋} , \qquad ( 19 )$$

where └·┘ denotes the nearest lower integer of the argument, and 30 is the number of 10-second intervals in a 5-minute slot;

(e) The k-index of the first 10-second interval for the current 5-minute slot is denoted as k and is:

$$\underline{k} = ⌊ \frac{k}{30} ⌋ \cdot 30. \qquad ( 20 )$$

For example, at clock time 00:16 UTC (sixteen minutes past midnight), k=96, Pₖ*=\hat{P}₃, and k=90. Similarly, the k-index of the last 10-second interval for the current 5-minute slot is:

k̅=k+30−1; (21)

(f) The control action includes the actuating of the set-point for the BESS converter real power demand, for example in kilowatt (kW). It is denoted by Bₖ^{o} and is piecewise constant in the interval k. It is determined by model predictive control as described below with respect to the formulation of model predictive control.

The nomenclature is also exemplified in the exemplary timeline shown in FIG. 3, which sketches the situation at the beginning of the time interval k=2 (clock-time 00:00:20 UTC): the BESS real power set-points B₀^{o} and B₁^{o} were actuated already in the previous two intervals, B₂^{o} has been just determined using recent available information, that is prosumption realizations L₀ and L₁, and the average prosumption set-point to achieve in the five (5) minute interval is given by the first value of the dispatch plan, \hat{P}₀.

Regarding the formulation of the control objective, at the beginning of the time interval k, it is assumed that the average composite power flow at the GCP (prosumption+BESS injection) for the current five (5) minute slot is given by averaging the available information until k. If k corresponds to the beginning of a five (5) minute period, no information is available yet, and it is assumed that the average composite consumption is zero. Formally, it is expressed by the following equation:

$${P}_{k} = \{ \begin{matrix}0 & k = \underline{k} \\ \frac{1}{( k - \underline{k} )} {\sum }_{j = \underline{k}}^{k - 1} ( {L}_{j} + {B}_{j} ) & k > \underline{k}\end{matrix} . \qquad ( 22 )$$

For example: at clock-time 00:05 UTC, 300 seconds since the beginning of the day, k=k=20, the average power consumption is zero; twenty seconds later, at k=22, k=20, two samples are available and averaged to determine P̅₂₂. The definition in Equation (22) is augmented by including short-term point predictions of the prosumption \hat{L}_{k|k}, \hat{L}_{k+1|k}, . . . , \hat{L}_{k̅|k} in order to calculate the expected average composite consumption over the whole duration of the current five (5) minute slot:

$${P}_{k}^{+} = \frac{1}{30} ( ( k - \overline{k} ) \cdot {P}_{k} + {\sum }_{j = k}^{\overline{k}} {\hat{L}}_{j \vert k} ) . \qquad ( 23 )$$

At the current stage, a persistent predictor is used to model future realizations, namely predictions are as the current realization, i.e. \hat{L}_{j|k}=Lₖ₋₁, j=k, . . . k. The use of more advanced short-term prediction models will be considered in future works.

The energy error, expressed in kWh, between the realizations and the dispatch plan, called dispatch plan error, in the current 5-minute slot is:

$${e}_{k} = \frac{300}{3600} \cdot ( {P}_{k}^{*} - {P}_{k}^{+} ) , \qquad ( 24 )$$

where 300 and 3600 are respectively the number of seconds in 5 minutes and 1 hour, Pₖ* is as defined in Equation (19), and Pₖ⁺ is as in Equation (23).

Regarding the formulation of model predictive control, in general, MPC determines the control action for a system by solving at each time step an optimization problem with updated information, where the system constraints are enforced by implementing prediction models in the optimization problem. MPC has been widely adopted in several engineering fields, and proposed also in application to power system operation, for example for control of demand response and storage, see reference [27]. In this work, PC is to determine the BESS real power injection Bₖ^{o} in order to achieve zero dispatch plan error by the end of each 5-minute slot while obeying to the limits of BESS SOC and voltage on the DC bus. The choice of designing the control problem with MPC rather than flavors of PID-based regulators is because the former allows to:

(a) Explicitly formulate BESS predictive constraints, thus increasing the awareness of the control action;

(b) Integrate in the formulation short-term consumption forecast, as it is shown later;

(c) Since the objective is to achieve a certain BESS energy throughput in a predefined amount of time, MPC achieves to spread the control action in the available time, thus resulting in smoother operation.

The proposed MPC is based on a convex formulation of the underlying optimization problem, which is efficient to solve and implement. There are two potential candidates for decision variable in the optimization problem underlying the proposed MPC strategy: i) the real power injection on the AC side, and ii) the current on the DC side. According to an aspect of the present invention, the second solution is adopted because it admits a convex equivalent formulation of the optimization problem. Convexity is explicitly sought because convex optimization problems, besides having a single minimum point which is global, provided that the solution exists, are efficient to solve.

Regarding the BESS energy throughput, the BESS energy throughput is modelled on the AC bus in the discretized time period from k to k:

$${E}_{\overline{k} \vert k} ( {v}_{k} , … , {v}_{\overline{k}} , {i}_{k} , … , {i}_{\overline{k}} ) = α {\sum }_{j = k}^{\overline{k}} {v}_{j} {i}_{j} , \qquad ( 25 )$$

where vₖ and iₖ are the battery DC voltage and current, positive when charging and vice-versa, respectively, and the scale factor α=10/3600·0.98 is to convert from power (in kW) in the discretized ten (10) seconds time interval to energy (in kWh), and the coefficient 0.98 models the converter losses (estimated from measurements). The expression above can be expressed as the following matrix product:

$${E}_{\overline{k} \vert k} ( \cdot ) = α {v}_{\overline{k} \vert k}^{T} {i}_{\overline{k} \vert k} , \qquad ( 26 )$$

where the bold notation denotes sequences obtained by stacking in column vectors the realizations in time of the referenced variables, e.g. υ_{k̅|k}=[υk, . . . , υ_{k̅}]^{T}. Because the voltage on the DC bus is modelled by using a linear electrical circuit, as detailed below with respect to the prediction models, and BESS voltage, its dynamic evolution can be expressed as a linear function of the battery current. By applying the transition matrices φυ, ψiυ, ψ1υ, which are developed starting from the voltage discrete state-space model representation as described in below with respect to the derivation of transition matrixes for MPC, the battery voltage can be expressed by:

υ_{k̅|k}=φ^{υ}xₖ+ψᵢ^{υ}i_{k̅|k}+ψ₁^{υ}1, (27)

where xₖ is the voltage model state vector and is known. Replacing Equation (27) into Equation (26) yields to:

E_{k̅|k}(i_{k̅|k})=α(φ^{υ}xₖ+ψᵢ^{υ}i_{k̅|k}+Φ₁^{υ}1)^{T}i_{k̅|k}==α(xₖ^{T}φ^{υ}^{^{T}}i_{k̅|k}+i_{k̅|k}^{T}i_{k̅|k}+1^{T}ψᵣ^{υ}^{^{T}}i_{k̅|k}), (28)

where 1 denotes the all-ones vector.

The requirements for E_{k̅|k}(·) in Equation (28) being a convex function of i_{k̅|k} are herewith explored. Because the non-negative sum between functions preserves convexity, the convexity of Equation (28) requires that all its three addends are convex. The first and third addend are linear i_{k̅|k}, therefore convex both when with negative and positive coefficient. The second term is a quadratic form of i_{k̅|k}: the necessary and sufficient condition for its convexity is given by ψ^{T} being semidefinite positive. This hypothesis has been verified numerically for all the BESS identified voltage models, which are presented below regarding the prediction models for BESS voltage. It can be concluded E_{k̅|k} that in Equation (28) is convex in i_{k̅|k}.

Regarding the formulation and implementation, the energy tracking problem, given by achieving zero dispatch plan error at the end of the 5-minute slot, could be formulated by minimizing the squared deviation of Equation (28) from Equation (24), such as:

(E_{k̅|k}(i_{k̅|k})−eₖ)². (29)

However, as known from composition rules for functions [28], the convexity of p(x)=q(r(x)) for when r(x) is convex requires q convex non-decreasing, which is not this case because the squared function of the difference is convex but not non-decreasing. Therefore, the objective is reformulated and achieve a convex equivalent formulation of the original problem. The objective includes the maximizing of the BESS DC current while imposing that the BESS energy throughput as expressed in Equation (28) is less or equal to the energy target as expressed in Equation (24), this achieves the energy throughput to hit the upper bound of the inequality, thus achieving the same value as the target energy. The combination of a linear cost function with an inequality constraint in the form “ƒ(x)≦0, with ƒ convex in x” is a convex optimization problem. Overall, the formulation of the MPC optimization problem is given by augmenting the just described formulation with open-loop predictive constraints on BESS voltage and SOC. Formally, the optimization can be expressed by the following equation:

$${i}_{\overline{k} \vert k}^{o} = {argmax}_{i ∈ {ℝ}^{( k - \overline{k} + 1 )}} \{ {1}^{T} {i}_{\overline{k} \vert k} \} \qquad ( 30 )$$

subject to

α(xₖ^{T}φ^{υ}^{^{T}}i_{k̅|k}+i_{N|t}^{T}ψᵢ^{υ}^{^{T}}i_{k̅|k}+1^{T}ψᵣ^{υ}^{^{T}}i_{k̅|k})≦eₖ

1·iₘᵢₙ [symbol] i_{k̅|k} [symbol] 1·Δ_{i,max}

1Δ_{i,min} [symbol] Hi_{k̅|k} [symbol] 1·Δ_{i,max}

υ_{k̅|k}=φ^{υ}υₖ+ψᵢ^{υ}i_{k̅|k}+ψ₁^{υ}1

1·υₘᵢₙ [symbol] υ_{k̅|k} [symbol] 1·υₘₐₓ

SOC_{k̅|k}=φ^{SOC}SOCₖ+ψᵢ^{SOC}i_{k̅|k}

1·SOCₘᵢₙ [symbol] SOC_{k̅|k} [symbol] 1·SOCₘₐₓ, (31)

where i_{k̅|k}^{o}ε [symbol] ^{(k-k̅+1)} is the computed control action trajectory, 1 denotes the all-ones column vector, the multiplication 1· [symbol] denotes the all-γ column vector, and the symbol [symbol] is the component-wise inequality. The cost function expressed in Equation (30) consists in maximizing the sum of the equally weighted current values over the shrinking horizon from k to k̅. This, in combination with the first inequality in Equation (31), achieves the BESS energy throughput to be as close as possible to eₖ, as introduced earlier. The second and third inequalities in Equation (31) respectively enforce minimum and maximum magnitude and rate of change for the BESS current, where (iₘᵢₙ,iₘₐₓ) and (Δ_{i,min}, Δ_{i,max}) are the respective limits and the matrix Hε [symbol] ^{(k-k+1)×(k-k+1)} is:

$$H = [ \begin{matrix}1 & 1 & 0 & 0 & … & 0 \\ 0 & 1 & 1 & 0 & … & 0 \\ ⋮ & ⋮ & ⋮ & ⋮ & ⋱ & ⋮ \\ 0 & 0 & 0 & … & 1 & 1\end{matrix} ] . \qquad ( 32 )$$

The fourth equality in Equation (31) enforces the electrical equivalent circuit model of the BESS according to the notation already introduced for Equation (27), while the fifth inequality in Equation (31) imposes BESS voltage limits, which are denoted by the couple vₘᵢₙ, vₘₐₓ. Analogously, the sixth equality constraint in Equation (31) is the evolution of the BESS SOC as a linear function of the variable i_{k̅|k}, where φ^{SOC}, ψᵢ^{SOC} are transition matrices calculated as shown below with respect to the derivation of the transition matrices using the SOC model described below regarding the prediction models for BESS SOC. Finally, the last inequality in Equation (31) imposes the limits on the BESS SOC, which are given by the couple (SOCₘᵢₙ, SOCₘₐₓ).

The optimization problem of Equations (30), (31) is convex because the cost function is linear and all the inequality constraints are convex i_{k̅|k}. It is noteworthy that if the real power injection had instead being adopted as optimization variable, the problem would not have been convex because the BESS voltage evolution is nonlinear in the power and thus the constraints in Equation (31) would have been non-convex.

The optimization problem is solved at each time step k, with updated information, on a shrinking horizon from the index k to k̅, namely from current time until the end of the current 5-minute slot. At each k, the control trajectory for the whole residual horizon is available, however only the first component of the current control law is considered for actuation, which is denoted by iₖ^{o}. Because the BESS power flow is controlled by using a real power reference signal, it is required to transform from the current value iₖ^{o} to the power set-point Bₖ^{o}. By using the same power model applied in Equation (25), it is:

Bₖ^{o}=υₖ·iₖ^{o}. (33)

Because the control decision is reevaluated every ten (10) seconds, potential errors on the voltage predictions and short-term consumption forecast which arise in the current actuation period are absorbed in the next cycle, where updated measurements are used. A summary and a diagram to summarize the real-time procedure and MPC operation is proposed further below.

It is noteworthy that the current implementation does not prevent the tracking problem to fail, for example if the accumulated mismatch between realizations and dispatch plan is larger than the BESS energy capacity. The discussion concerning mechanisms to manage real-time contingencies and proper storage capacity sizing is postponed to future investigations.

Regarding the prediction models, with respect to the BESS Voltage, a model formation is herewith provided. Battery voltage models for control application are normally based on electric equivalent circuits, which trade detailed modelling of the electrochemical reactions for increased tractability, see for example in references [29-31]. A voltage model commonly adopted in the literature is the so-called two time constants model (TTC): it consists in a linear second order dynamic model, where the value of the model parameters depend on the battery SOC, temperature and C-rate. For the present method, the classical TTC formulation is augmented or enhanced by implementing grey-box modelling, a set of rigorous and systematic methods for data-driven dynamic model identification (see for example in references [22, 32]. It consists in increasing the complexity of the model, for example by adding an order, until reaching a satisfactory behavior of the model prediction errors, which at the final stage should be independent and identically distributed (iid or i.i.d.) random noise with zero mean. This is with the main objective of obtaining a prediction model that is tuned to capture accurately the dynamics of the BESS that is used in the experimental validation of the control framework. The adopted modelling procedure initially consists in recording a series of experimental measurements of the BESS DC voltage and current while requiring to the BESS a random power flow according to a pseudo random binary signal (PRBS). The PRBS is a two levels square wave, in this case ±200 kW, with on-off periods of random durations. It is normally adopted in model identification because it can excite a wide range of system dynamics. As mentioned earlier, model parameters normally depend on the BESS SOC. In order to capture this dependence, a number of PRB S experimental sessions are performed when the BESS is in different SOC ranges (0-20%, 20-40%, 40-60%, 60-80%, 80-100%). The dependencies between model parameters and both C-rate and temperature are not modelled at this stage, and it will the objective of future investigations. Nevertheless, it is worth noting that the latter dependency is expected to play a minor role because the batteries are installed in a temperature controlled environment to keep the batteries at 20° C.

The BESS voltage model is formulated by using the continuous time stochastic state-space model representation:

dx= [symbol] _{c}(θ)xdt+ [symbol] _{c}(θ)u(t)dt+ [symbol] _{c}(θ)dω

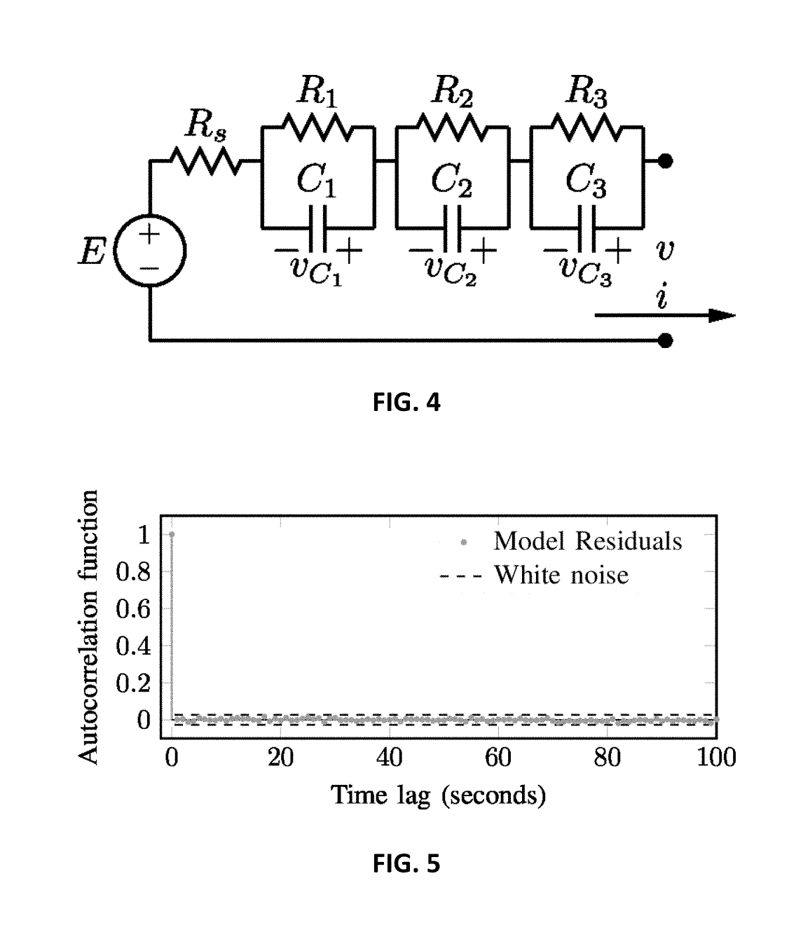

υₖ= [symbol] xₖ+ [symbol] (θ)uₖ+ [symbol] (θ)gₖ, (34)

where xε [symbol] ⁿ is the system state vector, n the model order, [symbol] _{c} is the system matrix, [symbol] _{c} the input matrix, [symbol] _{c} the input disturbance matrix, used later to implement Kalman filtering for state reconstruction, C output matrix, D feedforward matrix, [symbol] is the measurement noise matrix, gₖ is i.i.d. standard normal noise, u input vector, ω a n-dimension standard Wiener process, and θ is the set of model parameters to estimate. Model parameters are estimated by using the greyest function in Matlab™ and minimizing the sum of the model one-step-ahead prediction errors. It was found that the model with best performance (namely, with uncorrelated model residuals) for the considered experimental BESS is a three time constant model (n=3) with structure as schematically shown in FIG. 4.

The model is given by applying Kirchhoff laws to the circuit shown in FIG. 4 and is

$$x = [ \begin{matrix}{v}_{{C}_{1}} & {v}_{{C}_{2}} & {v}_{{C}_{3}}\end{matrix} ] , {u}_{tk} = {[ {i}_{tk} 1 ]}^{T} \\ {c}_{} = [ \begin{matrix}\frac{- 1}{{R}_{1} {C}_{1}} & 0 & 0 \\ 0 & \frac{- 1}{{R}_{2} {C}_{2}} & 0 \\ 0 & 0 & \frac{- 1}{{R}_{3} {C}_{3}}\end{matrix} ] , {c}_{} = [ \begin{matrix}\frac{1}{{C}_{1}} & 0 \\ \frac{1}{{C}_{2}} & 0 \\ \frac{1}{{C}_{3}} & 0\end{matrix} ] \\ {c}_{} = diag ( {k}_{1} , {k}_{2} , {k}_{3} ) , \\ = [ \begin{matrix}1 & 1 & 1\end{matrix} ] , = [ {R}_{s} E ] , = {σ}_{g} . \qquad ( 35 )$$

where R₁, C₁, R₂, C₂, R₃, C₃, k₁, k₂, k₃, Rₛ, E, σ_{g} is the set of parameters to estimate. The estimated values of the system parameters according to the BESS SOC ranges are summarized in Table I.

FIG. 5 shows the autocorrelation function (ACF) of the time series of model prediction errors, or model residuals, that is the difference between the training set of current/voltage measurements and the respective model predictions. Checking for model residuals correlation is a test widely adopted in system identification, see for example reference [33], to validate the ability of identified models of capturing the dynamics contained in the training data set. The test consists in comparing the ACFs of model residuals and white noise (which is i.i.d., therefore uncorrelated by definition): if all the components of the former ACF falls in the 95% confidence interval of the latter, the test is successful and the dynamic performance of the model are considered satisfactory. The situation in FIG. 5 refers to 50% SOC and shows uncorrelated model residuals, thus denoting that the identified model can capture all dynamics contained in the training data set. Although not shown here for a reason of space, the same behavior was observed also for the other SOC ranges of Table I.

Regarding the model integration in MPC, the continuous time model in Equation (34) is discretized at Tₛ=10 seconds resolution in order to be implemented in the MPC constraints. Discretization is performed with the forward difference (or forward Euler). However, in order not to incur in numerical instability, the quickest time constant given by the (R₃, G₃) branch is dropped in favor of an algebraic state by using the matched DC gain method. Let [symbol] ᵣ, [symbol] ᵣ, [symbol] ᵣ, be the continuous time system, input and system noise matrices of the reduced order model, the discretized system and input matrices are given by the equations:

[symbol]

=1+ [symbol] ᵣTₛ

[symbol]

= [symbol] ᵣTₛ

[symbol]

= [symbol] ₁ [symbol] ₂^{T}, (36)

where [symbol] ₁ and [symbol] ₂ are given according to the Van Loan's method of reference [34] and are matrix exponentials, which are approximated by a first order truncation of their respective Taylor expansions:

[symbol]

₁=e [symbol] ^{T}^{ₛ}=1+ [symbol] _{c}Tₛ

[symbol]

₂=e^{A}^{^{T}}^{T}^{ₛ}=1+ [symbol] _{c}^{T}Tₛ. (37)

The matrices [symbol] , [symbol] , [symbol] in Equation (36) and [symbol] , [symbol] , [symbol] in Equation (34) constitute the skeleton of the discrete time state-space of the BESS equivalent circuit model. By using the procedure shown below with respect to the derivation of the transition matrices for MPC, they are used to generate the transition matrices φ^{υ}, ψᵢ^{υ}, ψ₁^{υ}, which are finally used to implement the MPC voltage constraints on the voltage.

With respect to the state estimation, the components of the system state in Equation (35) are a modelling abstraction and cannot be measured. However, their value must be known to compute the BESS voltage predictions. In turn, the state is estimated from measurements of the battery DC voltage by applying Kalman filtering, for example as shown in reference [35]. It includes a two-stage procedure, repeated at each discrete time interval: a prediction step to determine the system evolution, state expected value and covariance matrix P, solely on the basis of the knowledge on the system,

x_{k|k}= [symbol] x_{k-1|k-1}+ [symbol] uₖ₋₁

P_{k|k-1}= [symbol] P_{k-1|k-1} [symbol] ^{T}+ [symbol] [symbol] ^{T}, (38)

and an update stage, where the predicted state is corrected accounting for the last measurement vₖ

x_{k|k}=x_{k|k-1}+G( [symbol] ₖ− [symbol] x_{k|k-1})

P_{k|k}=(P_{k|k-1}⁻¹+ [symbol] ^{T}σ_{g}⁻¹ [symbol] )⁻¹. (39)

where G is the Kalman gain:

G=P_{k|k-1} [symbol] ^{T}( [symbol] P_{k|k-1} [symbol] ^{T}+σ_{g}²)⁻¹, (40)

and σ_{g} is the measurement noise, known from the parameters estimation. KF requires full system observability, that in our case is enforced by construction since the model is estimated from measurements.

Regarding the prediction models for the BESS SOC, the BESS SOC model is:

$${SOC}_{k + 1} = {SOC}_{k} + \frac{10}{3600} \frac{{i}_{k}}{{C}_{nom}} , \qquad ( 41 )$$

where Cₙₒₘ=810 A h (ampere-hour) is BESS capacity from datasheet information. It is worth noting that the dependency of the BESS capacity with respect to the C-rate and cells temperature is neglected, see for example reference [36]. The discretized state-space matrix are easily found from Equation (41) and are A=1, B=10/3600/Cₙₒₘ, C=1, D=0. They are used as shown below with respect to the derivation of the MPS transition. to generate the transition matrices φ^{SOC}, ψᵢ^{SOC} for the SOC predictive constraints in the MPC.

Regarding the use of BESS models in the day-ahead and real-time stages, open-loop constraints on BESS operation are enforced in both day-ahead and real-time stages. The main differences between the two implementations are the time resolution at which they are computed (5 minutes and 10 seconds, respectively), and that they are reevaluated at each time interval by incorporating new information from real-time measurements. From the point of view of their practical purpose, while in the day-ahead problem they represent the long term flexibility, in real-time operation they embed BESS operational constraints in the MPC strategy, therefore enabling the computation of reliable control actions and respectful of the BESS operational limits. This explains the reason why more accurate BESS models are implemented in the latter stage than in the former, where a great level of details is not needed (especially considering that a more conservative plan for the BESS usage can be achieved by adding back-off terms to SOC and power flow constraints)).

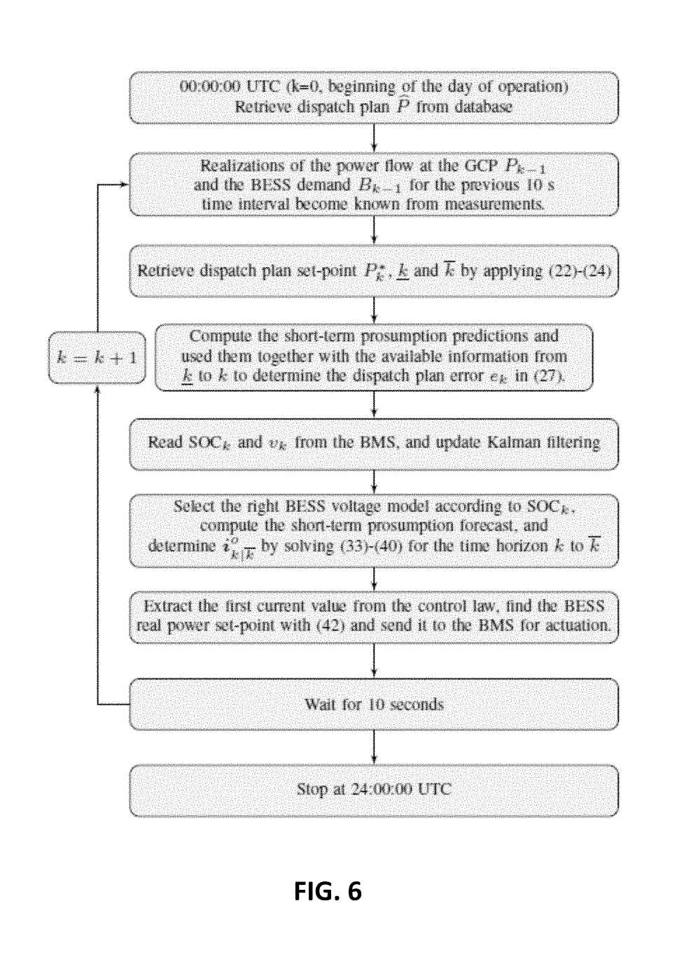

Regarding the implementation of the real-time strategy, the flow of operation during the real-time strategy is shown in the flowchart of FIG. 6. Real-time operation is implemented as a Matlab™ script and executed daily on the same PC as the day-ahead strategy. Also, information which become available from real-time measurements (power flow at the GCP, DC voltage, DC current, SOC, AC power flow of the BESS) are acquired and stored in a time-series database with one (1) second resolution.

Next, the results obtained by the method are discussed. Experimental results were obtained by dispatching the operation of a MV feeder of the EPFL campus. Two day scenarios were considered, denoted as day scenario 0 and day scenario 1. The analysis concerns two main aspects: the first is to exemplify the operation of the control strategy and the second is a quantitative assessment of the performance of the two MPC controllers.

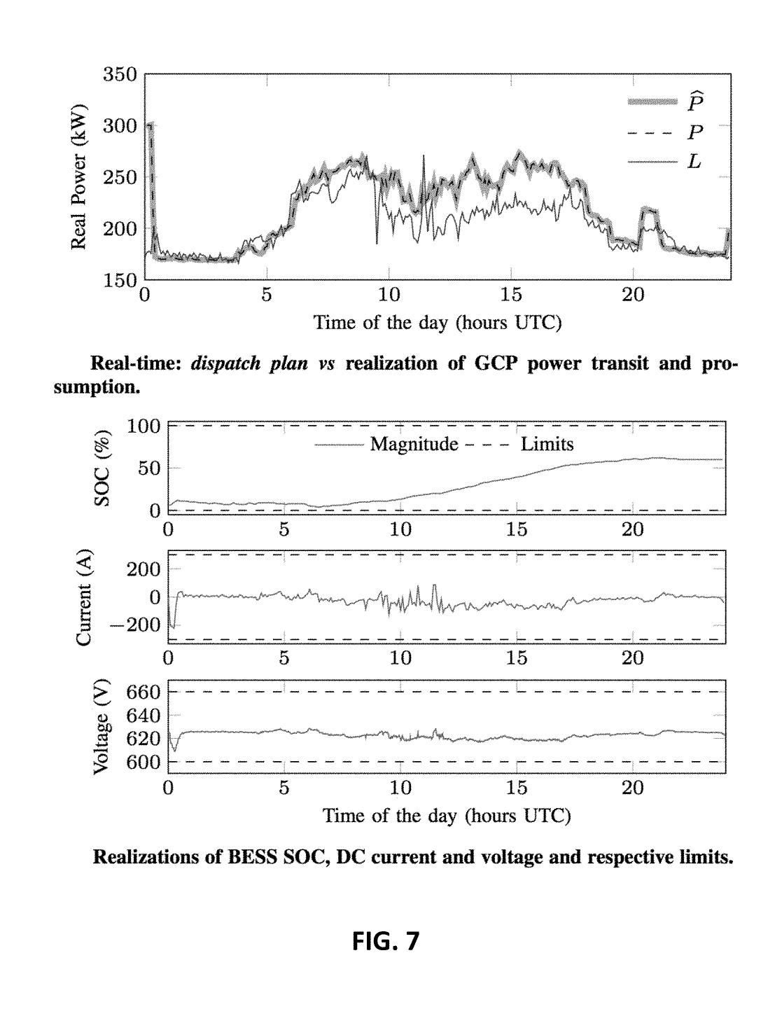

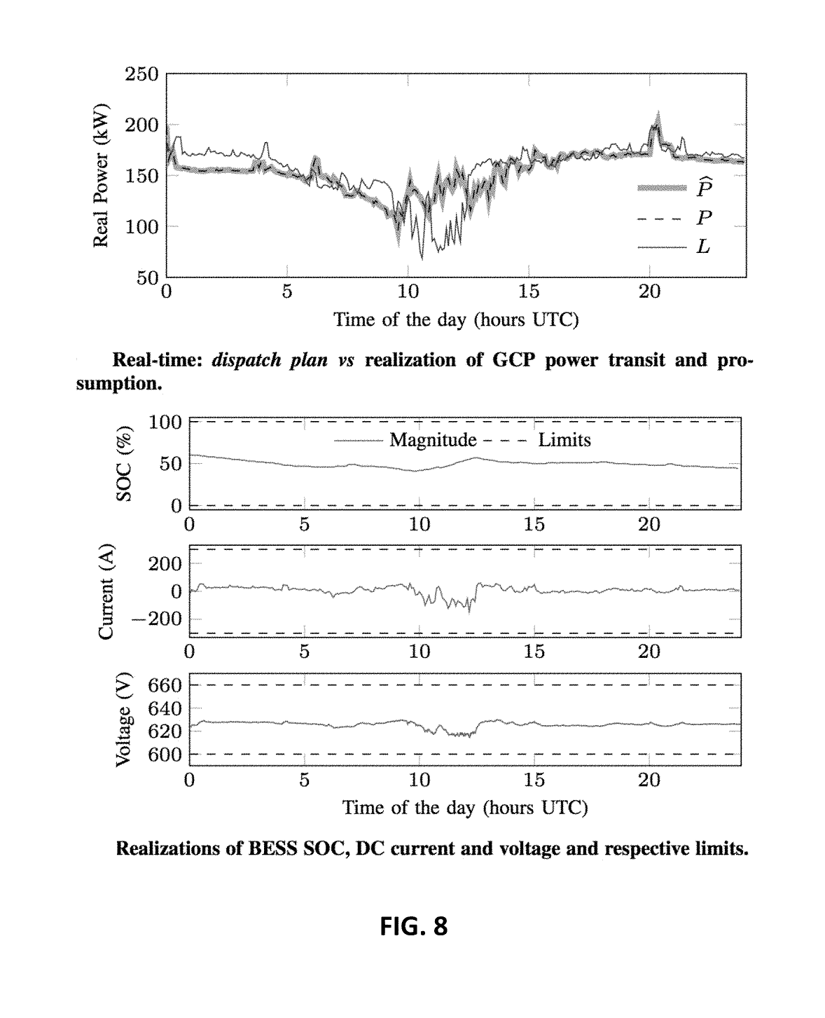

Regarding the experimental operation of the control strategy, FIGS. 7 and 8 show the operation during two day-scenarios, for one day each. The top section of FIGS. 7 and 8, the thick grey line indicates the dispatch plan \hat{P} that will be calculated the day before operation as discussed above. The black continuous line denotes the consumption realization L. As expected, it does not match the dispatch plan because forecast uncertainties. The MPC strategy of real time operation is applied to control the BESS real power flow to track the dispatch plan, as shown by the black dashed line P, indicating corrected consumption. FIG. 7 shows the BESS current and SOC during operation. The three (3) plots in the bottom section of both FIGS. 7 and 8 show the BESS SOC in percentage, current and voltage during operation for a full day having 24 hours, which are kept inside the respective limits.

By comparing FIGS. 7 and 8, it is well evident how the dispatch plan achieves a good management of the BESS SOC. As shown in FIG. 7 the SOC in percentage is below the 50% level, indeed the dispatch plan has a positive offset at the beginning of the day in order to charge the BESS and restore a SOC level close to 50%, that is the best value to be to have symmetric up/down regulation capacity. In turn, in the latter case, as shown in FIG. 8, the BESS in percentage is just above 50% at the beginning of the day of operation, and the dispatch plan, compared to the previous case, does not have any peak.

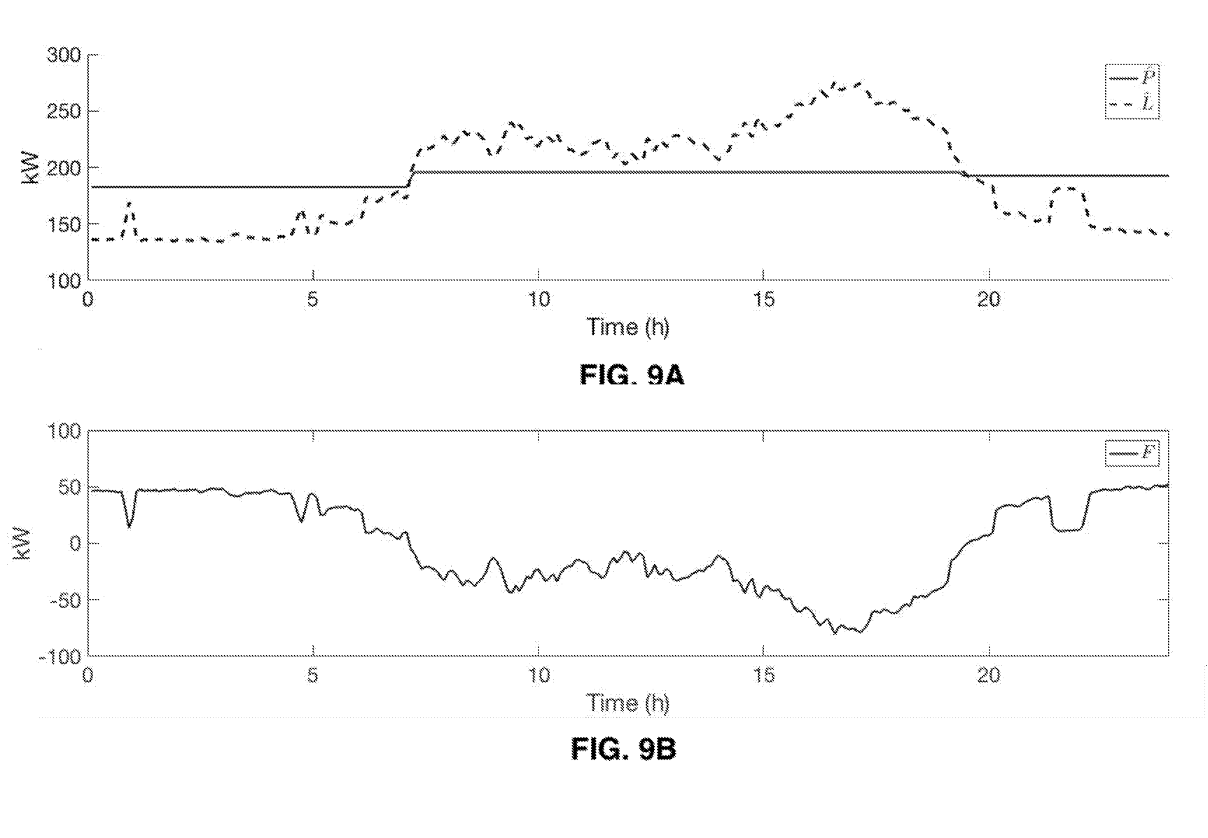

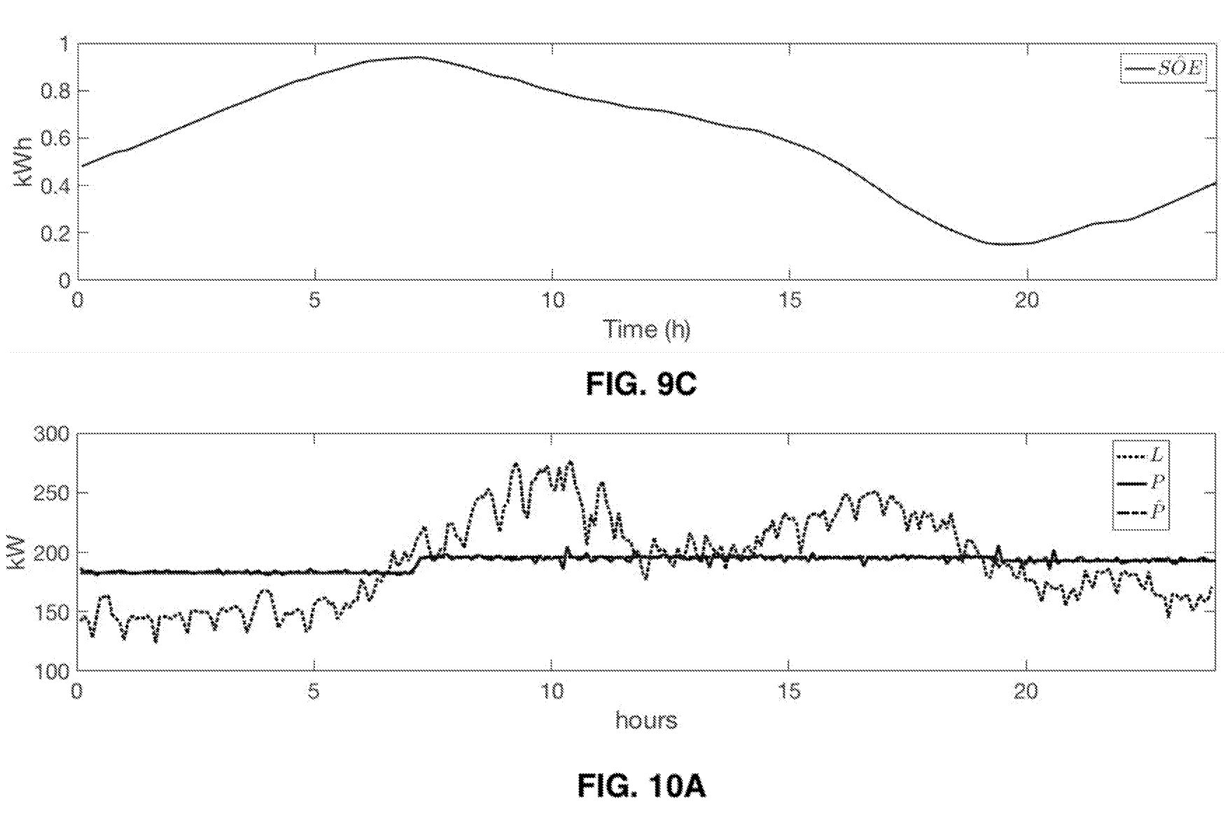

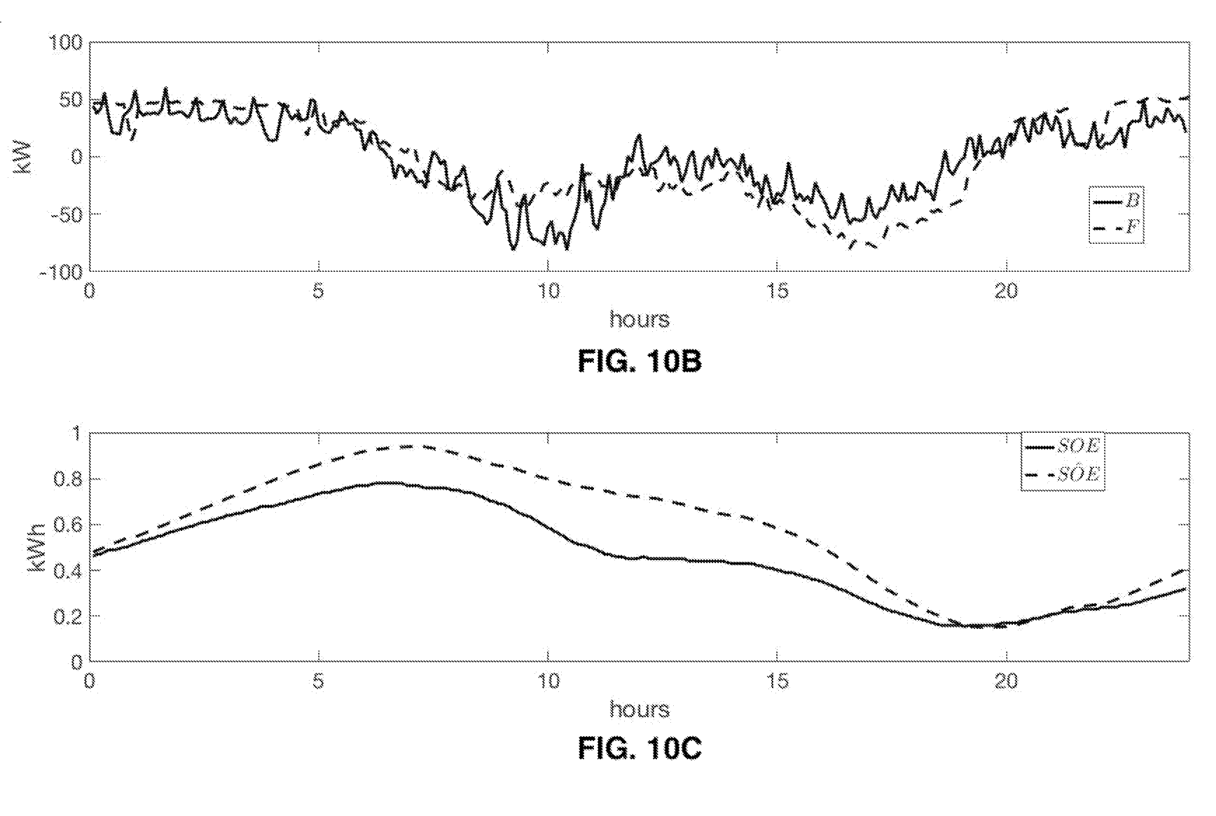

FIGS. 9A to 9C and FIGS. 10A to 10C show the operation during a day in which load levelling is performed. In particular, FIGS. 9A, 9B, and 9C show graphs showing load levelling experimental results, with an intra-day dispatch plan, day ahead problem, with FIG. 9A showing the forecasted consumption \hat{L} in a grey line and the dispatch plan \hat{P} as a solid black line, FIG. 9B showing the offset profile F, and FIG. 9C showing the forecasted BESS SOC behavior SÔE, and FIGS. 10A, 10B, and 10C show graphs representing load levelling experimental results, intra-day dispatch plan, with FIG. 10A showing the actual prosumption L in a grey line, and the sum of prosumption and BESS contribution P in a black line, and the levelled dispatch plan \hat{P} in a thick grey line, FIG. 10B showing the actual BESS power injections B along the day compared to the offset profile F, and FIG. 10C showing the evolution of the BESS SOC SOE as compared to the forecasted BESS SOC behavior SÔE. When reviewing FIGS. 9A to 10C, it can be seen how the levelled dispatch plan is followed, thus achieving both the dispatch of the feeder operation and the levelling of its load.

Regarding the performance assessment of the MPC controllers, to evaluate the ability of the MPC strategy to track the dispatch plan, the relative error sequence is introduced

e={(\hat{P}ₜ−Pₜ)/\hat{P}ₜ, t=0, . . . ,N−1} (42)

that is determined for each day of operation and used to compute the statistics shown in Table II. The data in Table II refer to two experimental day scenarios and are to compare the effect of applying MPC with respect to respective base-case (as if the BESS injection was 0). The former is obtained by calculating the relative error (5.2) using the actual power transit at the GCP, whereas, in the latter, the BESS contribute (that is known from the BMS) is subtracted from the actual consumption; moreover, in the base-case, also the battery charging demand \hat{B}ₜ is ignored, in other words \hat{P}ₜ=\hat{L}ₜ, and Pₜ=Lₜ, t=0, . . . , N−1. Numerical results in Table II show that MPC accomplishes a fairly accurate tracking the of the feeder dispatch plan, with the RMS and mean metrics that are well below 1% and substantially lower than their respective base-case.

The data in Table III refers to the experimental results of the load levelling strategy described above with respect to the load levelling of the day-ahead problem. The reported data quantify the reduction of the peak consumption and the energy shifted from the peak consumption period of the day through the definition of a levelled dispatch plan. The performance in tracking the levelled profile does not change considerably from the cases described in Table II.

Next, an exemplary hardware computer system is discussed, for example for computing the forecast, the dispatch plan, and its real-time operation. FIG. 11 shows an exemplary device and system for implementing the method described above, for example but not limited to the computation of the forecast, the calculation of the dispatch plan, and also for the real-time implementation of the control of the MV feeder. The system shown includes a data processing device 20, for example but not limited to a PC, Macintosh™ computer, laptop, notebook, netbook, embedded processing device. A dataset 12 is schematically shown, that can be located locally in a storage 26 associated with processing device 2, or can be accessed via the network 40, for example the Internet, from various servers 50 and storage 60. For example, various data and cloud services can be accessed from the Internet, for example historical data and other data that supports the forecast and dispatch plan calculation. Processing device 20 can be equipped with one or several hardware microprocessors and with internal memory.

Also, processing device 20 is connected to a data input device, for example a keyboard 24 to provide for user instructions for the method, and a data display device, for example a computer screen 22, to display different stages and final results of the data processing steps of the method. For example, the graphical user interface 25 can be shown, as schematically shown in FIG. 7. In a variant, the calculation of the dispatch plan and the performance of the real-time operation can be done by two different processing devices, the devices being able to communicate with each other, so that one device can send the other one the pre-calculated dispatch plan. Processing device 20 is also connected to a network 40, for example the Internet, to access various cloud-based and network based services, for example but not limited to cloud or network servers 50, cloud or network data storage devices 60, specific web servers for different data services, for example weather forecast data services like MeteoSuisse, Weather.com, cloud coverage and solar efficiency forecast data services, for example NorwayMet met.no, etc. Also, for controlling the MV feeder, the processing device 20 can be connected to the MV feeder (not shown) to control the power feeding.

The method described above can also be performed on hardware processors of one or more servers 50, and the results sent over the network 40 for rendering and display on computer screen 22 via processing device 20. Processing device 20 can be equipped with a data input/output port, for example a CDROM drive, Universal Serial Bus (USB), card readers, storage device readers, to read data, for example computer readable and executable instructions, from non-transitory computer-readable media 30, 32. Non-transitory computer-readable media 30, 32 are storage devices, for example but not limited to external hard drives, flash drives, memory cards, USB memory sticks, CDROM, Blu-Ray™ disks, optical storage devices and other types of portable memory devices that are capable of temporarily or permanently storing computer-readable instructions thereon. The computer-readable instructions can be configured to perform the method, as described above, when loaded to processing device 20 and executed on a processing device 20, or a cloud or other type of network server 50. For example, the method can be the calculation of the forecast, the calculation of the dispatch plan, the real-time operation of the dispatch plan, or a combination thereof.

Regarding the convex formulation of the day-ahead problem, the formulation in Equations (15) to (16) is nonconvex due to the relationship expressed in Equation (8), which involves a nonlinear function of the decision variable. Therefore, the method used in reference [37] can be applied to obtain a convex equivalent formulation of the original problem. It initially consists in expressing the decision variable as the difference of two positive sequences:

Fᵢ+Fᵢ⁺+Fᵢ⁺Fᵢ⁺≧0, Fᵢ⁻<0 (43)

and explicitly decouple the positive and negative BESS flow, which are therefore weighted accounting for the respective efficiency factor according to Equation (8). For simplification purposes, the single terms are squared rather than the binomial because the objective is to keep the individual components of Equation (43) as small as possible. The convex formulation is:

$$20.8 {min}_{{{F}^{+} , {F}^{-} ∈ {ℝ}^{N}}_{{s}^{↑} , {s}^{↓} , {b}^{↑} , {b}^{↓} ∈ {ℝ}_{+}^{N}}} \{ {\sum }_{i = 1}^{N} ( {F}_{i}^{+ 2} + {F}_{i}^{- 2} ) ++ α {\sum }_{i = 1}^{N} ( {s}_{i}^{↑} + {s}_{i}^{↓} + {b}_{i}^{↑} + {b}_{i}^{↓} ) \} , \qquad ( 44 )$$

subject to:

SOCᵢ^{↓}+β⁺Fᵢ⁺+β⁻(Fᵢ⁻+\hat{L}ᵢ−lᵢ^{↑})≧SOCₘᵢₙ−sᵢ^{↓},

SOCᵢ^{↑}+β⁻Fᵢ⁻+β⁺(Fᵢ⁺+\hat{L}ᵢ−lᵢ^{↓})≦SOCₘᵢₙ+sᵢ^{↑},

Fᵢ⁺+Fᵢ⁻+\hat{L}ᵢ−lᵢ^{↑}≧Bₘₐₓ−bᵢ^{↓}

Fᵢ⁺+Fᵢ⁻+\hat{L}ᵢ−lᵢ^{↓}≦Bₘₐₓ−bᵢ^{↑}

Fᵢ⁺≧0

Fᵢ⁻≦0

\hat{P}ᵢ≦Pₘₐₓ (45)

for i=0, 1, . . . , N−1. The term Fᵢ⁻+\hat{L}ᵢ−lᵢ^{↑} in Equation (45) is weighted with the coefficient B⁻ because all the term are negative: indeed Fᵢ⁻ is negative by definition, and \hat{L}ᵢ−lᵢ^{↑} is negative by construction because \hat{L}ᵢ is the sample average of the set [symbol] ᵢ, while lᵢ^{↑} corresponds to its largest term.

Regarding the derivation of the transition matrices for MPC, a linear dynamic model is used with the following discrete state-space representation, as those developed in above regarding the prediction models or the BESS SOC and voltage:

xₖ₊₁=Axₖ+Buₖ

yₖ=Cxₖ+Duₖ (46)

where xₖε [symbol] ⁿ is the state vector at discrete time interval k, uₖε [symbol] is the input, yε [symbol] is the system output, A is the n×n system matrix, B is the n×1 input matrix, C is the 1×n output matrix, and the scalar D is the feed-forward gain. For the moment, the case with only one input signal is considered: the extension to multiple inputs is shown further below. The evolution of the state vector x from a known initial state xₒ as a function of a given input sequence u₀, u₁, . . . , u_{N} using Equation (46) is

$${x}_{1} = {Ax}_{0} + {Bu}_{0} \\ \begin{matrix}{x}_{2} = {Ax}_{1} + {Bu}_{1} \\ = A ( {Ax}_{0} + {Bu}_{0} ) + {Bu}_{1} = \\ = {A}^{2} {x}_{0} + {ABU}_{0} + {Bu}_{1}\end{matrix} \\ \begin{matrix}{x}_{3} = {Ax}_{2} + {Bu}_{2} = \\ = {A}^{3} {x}_{0} + {A}^{2} {Bu}_{0} + {ABu}_{1} + {Bu}_{2} .\end{matrix} \qquad ( 47 )$$

Iterating until the time interval N:

x_{N}=A^{N}x₀+A^{N-1}Bu₀+ . . . +A⁰Bu_{N-1}. (48)

Applying the above to Equations (47)-(48) yields

$$[ \begin{matrix}{y}_{0} \\ {y}_{1} \\ {y}_{2} \\ ⋮ \\ {y}_{N}\end{matrix} ] = [ \begin{matrix}C \\ CA \\ {CA}^{2} \\ ⋮ \\ {CA}^{N}\end{matrix} ] {x}_{0} ++ [ \begin{matrix}D & 0 & … & 0 & 0 \\ {CA}^{0} B & D & … & 0 & 0 \\ {CA}^{1} B & {CA}^{0} B & … & 0 & 0 \\ ⋮ & ⋮ & ⋱ & ⋮ & ⋮ \\ {CA}^{N - 1} B & {CA}^{N - 2} B & … & {CA}^{0} B & D\end{matrix} ] [ \begin{matrix}{u}_{0} \\ {u}_{1} \\ ⋮ \\ {u}_{N - 1} \\ {u}_{N}\end{matrix} ] \qquad ( 49 )$$

which can be rewritten in compact form as:

y=φx₀+ψᵤu. (50)

where y=y₀, . . . , y_{N}, x=x₀, . . . , x_{N} and u=u₀, . . . , u_{N}. For the case of multiple inputs, an input r=r₀, . . . , r_{N} is added to the state-space model of Equations (47)-(48):

xₖ₊ᵢ=AXₖ+Bᵤuₖ+Bᵣrₖ

yₖ=Cxₖ+Dᵤuₖ+Dᵤrₖ. (51)

The system output is written by applying the transformation ψᵣ to r:

y=φx₀+ψᵤu++ψᵣr. (52)

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

### REFERENCES

[1]B. Biegel, P. Andersen, J. Stoustrup, M. B. Madsen, L. H. Hansen, L. H. Rasmussen et al., “Aggregation and control of flexible consumersa real life demonstration,” in Proceedings of the 19th IFAC World Congress, Cape Town, South Africa, 2014.
[2] J. Saraiva and M. Gomes, “Provision of some ancillary services by microgrid agents,” in Energy Market (EEM), 2010 7th International Conference on the European, June 2010.
[3] M. Soshinskaya, W. H. Crijns-Graus, J. M. Guerrero, and J. C. Vasquez, “Microgrids: Experiences, barriers and success factors,” Renewable and Sustainable Energy Reviews, vol. 40, 2014.
[4] A. Bernstein, L. Reyes-Chamorro, J.-Y. L. Boudec, and M. Paolone, “A composable method for real-time control of active distribution networks with explicit power setpoints. part i: Framework,” Electric Power Systems Research, 2015.
[5] G. T. Costanzo, O. Gehrke, D. E. M. Bondy, F. Sossan, H. Bindner, J. Parvizi, and H. Madsen, “A coordination scheme for distributed model predictive control: Integration of flexible DERs,” in Innovative Smart Grid Technologies Europe (ISGT EUROPE), 2013 4th IEEE/PES, 2013, pp. 1-5.
[6] F. Ruelens, B. Claessens, S. Vandael, S. Iacovella, P. Vingerhoets, and R. Belmans, “Demand response of a heterogeneous cluster of electric water heaters using batch reinforcement learning,” in Power Systems Computation Conference (PSCC), 2014, Aug 2014.
[7] S. Teleke, M. E. Baran, A. Q. Huang, S. Bhattacharya, and L. Anderson, “Control strategies for battery energy storage for wind farm dispatching,” Energy Conversion, IEEE Transactions on, vol. 24, 2009.
[8] M. Marinelli, F. Sossan, G. T. Costanzo, and H. W. Bindner, “Testing of a predictive control strategy for balancing renewable sources in a microgrid,” IEEE Transactions on Sustainable Energy, 2014.
[9] M. Abu Abdullah, K. Muttaqi, D. Sutanto, and A. Agalgaonkar, “An effective power dispatch control strategy to improve generation schedulability and supply reliability of a wind farm using a battery energy storage system,” Sustainable Energy, IEEE Transactions on, vol. 6, 2015.
[10] N. Troy and M. O'Malley, “Multi-mode operation of combined cycle gas turbines with increasing wind penetration,” in Power and Energy Society General Meeting, 2010 IEEE, 2010.
[11] S. Lu, P. V. Etingov, D. Meng, X. Guo, C. Jin, and N. A. Samaan, “Nv energy large-scale photovoltaic integration study: Intra-hour dispatch and agc simulation,” Pacific Northwest National Laboratory (PNNL), Richland, Wash. (US), Tech. Rep., 2013.
[12] M. Pignati, M. Popovic, S. Barreto Andrade, R. Cherkaoui, D. Flores, J.-Y. Le Boudec, M. M. Maaz, M. Paolone, P. Romano, S. Sarri, T. T. Tesfay, D.-C. Tomozei, and L. Zanni, “Real-Time State Estimation of the EPFL-Campus Medium-Voltage Grid by Using PMUs,” in The Sixth Conference on Innovative Smart Grid Technologies (ISGT2015), 2014.
[13] D. Wu, D. Aliprantis, and L. Ying, “Load scheduling and dispatch for aggregators of plug-in electric vehicles,” Smart Grid, IEEE Transactions on, vol. 3, 2012.
[14] L. Yang, J. Zhang, and H. Poor, “Risk-aware day-ahead scheduling and real-time dispatch for electric vehicle charging,” Smart Grid, IEEE Transactions on, vol. 5, 2014.
[15] M. Bozorg, A. Ahmadi-Khatir, and R. Cherkaoui, “Developing offer curves for an electric railway company in reserve markets based on robust energy and reserve scheduling,” Power Systems, IEEE Transactions on, 2015.
[16] M. Marinelli, F. Sossan, G. Costanzo, and H. Bindner, “Testing of a predictive control strategy for balancing renewable sources in a microgrid,” IEEE Transactions on Sustainable Energy, 2014.
[17] J.-H. Teng, S.-W. Luan, D.-J. Lee, and Y.-Q. Huang, “Optimal charging/discharging scheduling of battery storage systems for distribution systems interconnected with sizeable pv generation systems,” Power Systems, IEEE Transactions on, 2013.
[18] S. Teleke, M. Baran, S. Bhattacharya, and A. Huang, “Rule-based control of battery energy storage for dispatching intermittent renewable sources,” Sustainable Energy, IEEE Transactions on, vol. 1, 2010.
[19] R. Palma-Behnke, C. Benavides, F. Lanas, B. Severino, L. Reyes, J. Llanos, and D. Saez, “A microgrid energy management system based on the rolling horizon strategy,” IEEE Transactions on Smart Grid, vol. 4, no. 2, June 2013.
[20] P. Bacher, H. Madsen, H. Nielsen, and B. Perers, “Short-term heat load forecasting for single family houses,” Energy and Buildings, vol. 65, pp. 101-112, 2013.
[21] B. Hayes, J. Gruber, and M. Prodanovic, “Short-term load forecasting at the local level using smart meter data,” in PowerTech, 2015 IEEE Eindhoven, June 2015, pp. 1-6.
[22] F. Sossan, V. Lakshmanan, G. T. Costanzo, M. Marinelli, P. J. Douglass, and H. Bindner, “Grey-box modelling of a household refrigeration unit using time series data in application to demand side management,” Sustainable Energy, Grids and Networks, vol. 5, 2016.
[23] B.-J. Chen, M.-W. Chang, and C.-J. lin, “Load forecasting using support vector machines: a study on eunite competition 2001,” IEEE Transactions on Power Systems, vol. 19, no. 4, pp. 1821-1830, November 2004.
[24] F. Kasten and G. Czeplak, “Solar and terrestrial radiation dependent on the amount and type of cloud,” Solar Energy, vol. 24, pp. 177-189, 1980.
[25] J. Hofierka, M. Suri et al., “The solar radiation model for open source gis: implementation and applications,” in Proceedings of the Open source GIS-GRASS users conference, 2002, pp. 1-19.
[26] M. Neteler, M. Bowman, M. Landa, and M. Metz, “GRASS GIS: a multi-purpose Open Source GIS,” Environmental Modelling & Software, vol. 31, p. 124-130, 2012.
[27] F. Oldewurtel, A. Parisio, C. Jones, M. Moran, D. Gyalistras, M. Gwerder, V. Stauch, B. Lehmann, and K. Wirth, “Energy efficient building climate control using stochastic model predictive control and weather predictions,” in American Control Conference (ACC), 2010, 2010, pp. 5100-5105.
[28] Stephen Boyd, Lieven Vandenberghe, “Complex Optimization,” Cambridge University Press, U K, 2004, ISBN 0-521-83378-7.
[29] M. Chen and G. Rincon-Mora, “Accurate electrical battery model capable of predicting runtime and i-v performance,” Energy Conversion, IEEE Transactions on, vol. 21, June 2006.
[30] B. Y. Liaw, G. Nagasubramanian, R. G. Jungst, and D. H. Doughty, “Modeling of lithium ion cellsa simple equivalent-circuit model approach,” Solid State Ionics, vol. 175, 2004.
[31] M. Bahramipanah, D. Torregrossa, R. Cherkaoui, and M. Paolone, “Enhanced electrical model of lithium-based batteries accounting the charge redistribution effect,” in Power Systems Computation Conference (PSCC), 2014.
[32] N. Kristensen, H. Madsen, and S. Jorgensen, “Parameter estimation in stochastic grey-box models,” Automatica, vol. 40, no. 2, 2004.
[33] N. R. Kristensen and H. Madsen, “Continuous time stochastic modelling,” Mathematics Guide, 2003, 1-32.
[34] C. V. Loan, “Computing integrals involving the matrix exponential,” IEEE Transactions on Automatic Control, vol. 23, no. 3, pp. 395-404, June 1978.
[35] Robert F. Stengel, “Optimal Control and Estimation,” Dover Publications, Inc., New York, U.S.A., 1994, ISBN 0-486-68200-5.
[36] B. Belvedere, M. Bianchi, A. Borghetti, C. A. Nucci, M. Paolone, and A. Peretto, “A microcontroller-based power management system for standalone microgrids with hybrid power supply,” Sustainable Energy, IEEE Transactions on, vol. 3, no. 3, pp. 422-431, 2012.
[37] M. Kraning, Y. Wang, E. Akuiyibo, and S. Boyd, “Operation and configuration of a storage portfolio via convex optimization,” in Proceedings of the 18th IFAC World Congress, vol. 18, 2011, pp. 10487-10492.

1. A method for dispatching an operation of a distribution feeder of electrical power into a grid with heterogeneous prosumers, the method comprising the steps of:
establishing a dispatch plan on a computer by using forecast data of an aggregated consumption and local distributed generation at the grid for a predetermined period; and
operating the distribution feeder according to the established dispatch plan during the predetermined period.

2. The method according to claim 1, further comprising the step of:
correcting a mismatch between an actual prosumption generation of the local distributed generation and the dispatch plan, during the step of operation, by adjusting real power injections of a battery energy storage system connected to the grid with model predictive control.

3. The method according to claim 2, wherein the step of correcting uses the model predictive control that accounts for operational constraints of the battery energy storage system by using reduced order-dynamic grey-box models.

4. The method according to claim 1, wherein in the step of establishing the dispatch plan, the aggregated consumption includes a number of historical power consumption sequences are selected and averaged for the predetermined period.

5. The method according to claim 1, wherein in the step of operating, an offset profile showing a mismatch between the dispatch plan and a prosumption realization is minimized, to perform load levelling.

6. The method according to claim 1, wherein in the step of operating, a cost function is maximized to achieve a maximal current of the battery energy storage system, while imposing that an energy throughput of the battery energy storage system is less or equal to an energy target.

7. The method according to claim 6, wherein the cost function further respects minimal and maximal rate magnitude and rate of change of the current of the battery energy storage system, imposes battery energy storage system voltage limits.

8. A smart power system including a grid connect point to connect to a power grid, a plurality of prosumers, a distribution feeder, a battery energy storage device, and a computer controller, wherein the computer controller is configured to establish a dispatch plan by the computer controller by using forecast data of an aggregated consumption and local distributed generation at the power grid for a predetermined period; and
operate the distribution feeder according to the established dispatch plan during the predetermined period.

9. The smart power system according to claim 8, wherein the computer controller is further configured to
correct a mismatch between an actual prosumption generation of the local distributed generation and the dispatch plan, during the step of operation, by adjusting real power injections of a battery energy storage system connected to the grid with model predictive control.

10. The smart power system according to claim 9, wherein the correcting by the computer controller uses the model predictive control that accounts for operational constraints of the battery energy storage system by using reduced order-dynamic grey-box models.

11. The smart power system according to claim 8, wherein in the establishing the dispatch plan by the computer controller, the aggregated consumption includes a number of historical power consumption sequences are selected and averaged for the predetermined period.

12. The smart power system according to claim 8, wherein in the operating by the computer controller, an offset profile showing a mismatch between the dispatch plan and a prosumption realization is minimized, to perform load levelling.

13. The smart power system according to claim 8, wherein in the operating by the computer controller, a cost function is maximized to achieve a maximal current of the battery energy storage system, while imposing that an energy throughput of the battery energy storage system is less or equal to an energy target.

14. The smart power system according to claim 13, wherein the cost function further respects minimal and maximal rate magnitude and rate of change of the current of the battery energy storage system, imposes battery energy storage system voltage limits.

15. A non-transitory computer readable medium having computer instructions recorded thereon, the computer instructions configured to perform a method for dispatching an operation of a distribution feeder for electrical power into a grid when performed on a computer, the method comprising the steps of:
establishing a dispatch plan on a computer by using forecast data of an aggregated consumption and local distributed generation at the grid for a predetermined period; and
operating the distribution feeder according to the established dispatch plan during the predetermined period.

16. The non-transitory computer readable medium according to claim 15, wherein the method further comprises the step of:
correcting a mismatch between an actual prosumption generation of the local distributed generation and the dispatch plan, during the step of operation, by adjusting real power injections of a battery energy storage system connected to the grid with model predictive control.

17. The non-transitory computer readable medium according to claim 16, wherein in the method, the step of correcting uses the model predictive control that accounts for operational constraints of the battery energy storage system by using reduced order-dynamic grey-box models.
